(19) United States
(12) Patent Application Publication
(10) Pub. No.: US 2013/0179265 A1
(43) Pub. Date: Jul. 11, 2013

(54) LOCATION-BASED PROMOTION DELIVERY SYSTEM AND METHOD

(71) Applicant: Christopher C. Winslade, Chicago, IL (US)

(72) Inventor: Christopher C. Winslade, Chicago, IL (US)

(21) Appl. No.: 13/734,968

(22) Filed: Jan. 5, 2013

Related U.S. Application Data
(60) Provisional application No. 61/583,290, filed on Jan. 5, 2012.

(51) Int. Cl. G06Q 30/02

(52) U.S. Cl. CPC G06Q 30/0261
USPC 705/14.58

(57) ABSTRACT

A system and method for providing location-based promotions, substantially as shown in and/or described in connection with at least one of the figures, as set forth more completely in the claims.

### CROSS-REFERENCE TO RELATED APPLICATIONS/INCORPORATION BY REFERENCE

This patent application is related to and claims priority from provisional patent application Ser. No. 61/583,290 filed Jan. 5, 2012, and titled “LOCATION-BASED PROMOTION DELIVERY SYSTEM AND METHOD,” the contents of which are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Present systems are generally too slow and inflexible to provide for the real-time business solicitation needs of enterprises.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for providing location-based promotion delivery. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 shows a non-limiting example flow diagram of a method for communicating promotion content, in accordance with various aspects of the present invention.

FIG. 2 shows a non-limiting example flow diagram of a method for interacting with users (e.g., proprietors and/or consumers), in accordance with various aspects of the present invention.

FIG. 3 shows a non-limiting example flow diagram of a method for interacting with consumers, in accordance with various aspects of the present invention.

FIG. 4 shows a non-limiting example flow diagram of a method for interacting with consumers, in accordance with various aspects of the present invention.

FIG. 5 shows a non-limiting example flow diagram of a method for interacting with proprietors, in accordance with various aspects of the present invention.

FIG. 6 shows a non-limiting example flow diagram of a method for interacting with proprietors, in accordance with various aspects of the present invention.

FIG. 7 shows a non-limiting example flow diagram of a method for tracking consumer location, in accordance with various aspects of the present invention.

FIG. 8 shows a non-limiting example flow diagram of a method for communicating promotion content, in accordance with various aspects of the present invention.

FIG. 9 shows a non-limiting example flow diagram of a method for communicating promotion content, in accordance with various aspects of the present invention.

FIG. 10 shows a block diagram of a system in accordance with a various aspects of the present invention.

FIG. 11 shows a diagram of a distributed system in accordance with various aspects of the present invention.

### DETAILED DESCRIPTION OF VARIOUS ASPECTS OF THE INVENTION

Various aspects of the prevent invention provide a promotion delivery system and/or a method for promotion delivery based on consumer (or customer) and proprietor location. Promotional content delivered by such a system and/or method may, for example and without limitation, comprise coupons, discounts, rebates, specials, etc.

Various aspects of the present invention may, for example, comprise determining in real-time locations for participating consumers (e.g., mobile consumers and/or static consumers) and identifying participating proprietors that are co-located with or located within the vicinity of such consumers (e.g., in the same store, same shopping mall, same shopping center, same block, near a same intersection, in the same neighborhood, same community or locality, same zip code, within a particular distance (e.g., within a mile), etc.).

Based, at least in part, on the determined consumer location(s) and/or identified proprietor(s), various aspects of the present invention may comprise delivering information regarding a promotion for a product/service being offered for sale (e.g., coupon information, offer of specials, etc.) to consumers who are co-located with or in the vicinity of a participating proprietor offering the promoted product/service. Such information may also, for example, comprise information regarding (or describing) the product/service, regarding the promotional opportunity, regarding timeframe, regarding offer acceptance, etc.

The determination of which one or more participating consumers are to receive the promotional information and/or additional information regarded a product/service may be based, at least in part, on consumer profiles (e.g., stored in a database). The determination of a proprietor and the type and/or amount of promotion (as well as the products and/or services to which a promotion applies) may be based, at least in part, on a proprietor profiles (e.g., stored in a database). The type and/or amount of promotion may be specified by the participating proprietor in real-time, based at least in part on, for example, the number of participating consumers, consumer profiles, current consumer activity, the purpose for consumers being present, a group identification of users, and/or historical data regarding purchasing activity of consumers, who are currently co-located with or in the vicinity of the participating proprietor.

The various aspects of the present invention may be performed automatically (e.g., independently of present human interaction) and/or with at least some manual interaction with proprietors and/or consumers. For example, promotion information and information regarding or describing a product and/or service, may be communicated to consumers automatically without present real-time proprietor interaction. For example, such information may be communicated to potential customers based on automatic delivery rules defined by a proprietor via prior system interaction with the proprietor. Then upon the detected occurrence of particular conditions, the system or method may perform the delivery of such promotional information without additional interaction with the proprietor (e.g., without obtaining final approval or other real-time input from the proprietor).

Also for example, promotion information and/or product and/or service information, may be communicated to potential customers by interacting (e.g., in real-time) with a proprietor regarding current marketing conditions, including for example current locations of one or more potential consumers and/or current enterprise consumer activity (e.g., present existence and/or degree of consumer activity at the proprietors place of business, present existence and/or degree of consumer activity at competing proprietors' businesses, present existence and/or degree of consumer activity at related businesses, present existence and/or degree of consumer activity in the same building, mall, location, and/or neighborhood, etc.).

Various aspects of the present invention may, for example, comprise interacting with potential customers of goods and/or services (e.g., prior to and/or after delivery of promotion information to such potential customers). Also, for example, various aspects of the present invention may comprise interacting with proprietors (e.g., regarding promotion content definition, specifying promotion delivery information, defining triggers for promotion information delivery, specifying general goods and/or services provided by the proprietor, identifying proprietor location information, identifying targeted customers and/or groups thereof, identifying characteristics of target customers and/or groups thereof, etc.).

Additionally, various aspects of the present invention may, for example, comprise billing aspects. Such billing aspects may, for example, concern the transfer of funds to/from participating proprietors, the transfer of funds to/from customers, etc.

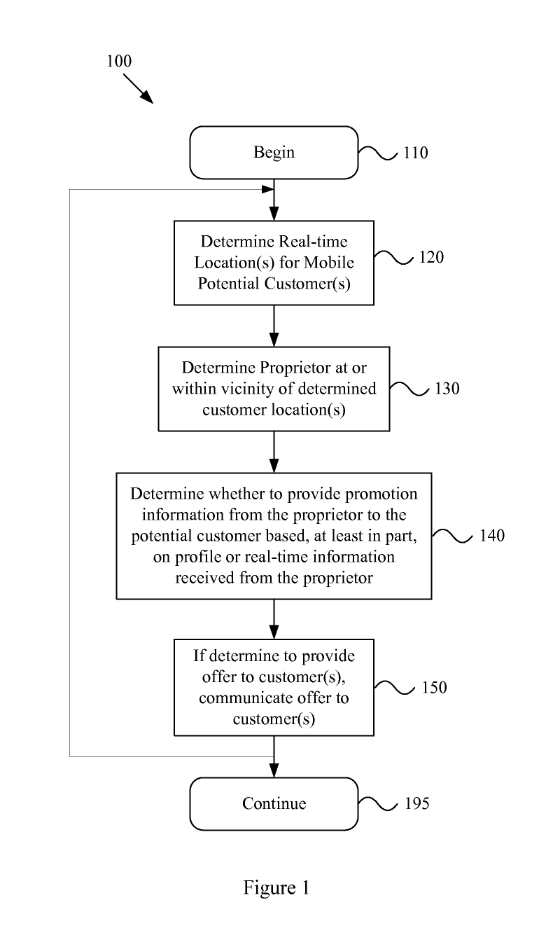

Referring now to FIG. 1, such figure shows a non-limiting example flow diagram of a method 100 for communicating promotion content, in accordance with various aspects of the present invention. Various aspects of the method 100 were presented above, and various additional aspects of the method 100 will be presented below.

The example method 100 begins executing at step 110. Such execution may begin for any of a variety of causes and/or conditions, non-limiting examples of which will now be presented. For example, once initiated (e.g., manually or automatically), the method 100 may continually execute, for example continually looping through steps 120-150 or any other combination of steps. Also for example, the method 100 may begin executing in response to a timer. Additionally, for example, the method 100 may begin executing in response to a proprietor and/or customer interacting with a system executing the method 100. Such interaction may, for example, comprise specifically initiating operation of the method 100, logging into a system, logging into a website, executing an application, booting up a computing device, etc. In general, the method 100 may begin executing for any of a variety of reasons. Accordingly, the scope of various aspects of the present invention should not be limited by characteristics of any particular initiating cause and/or condition unless explicitly claimed.

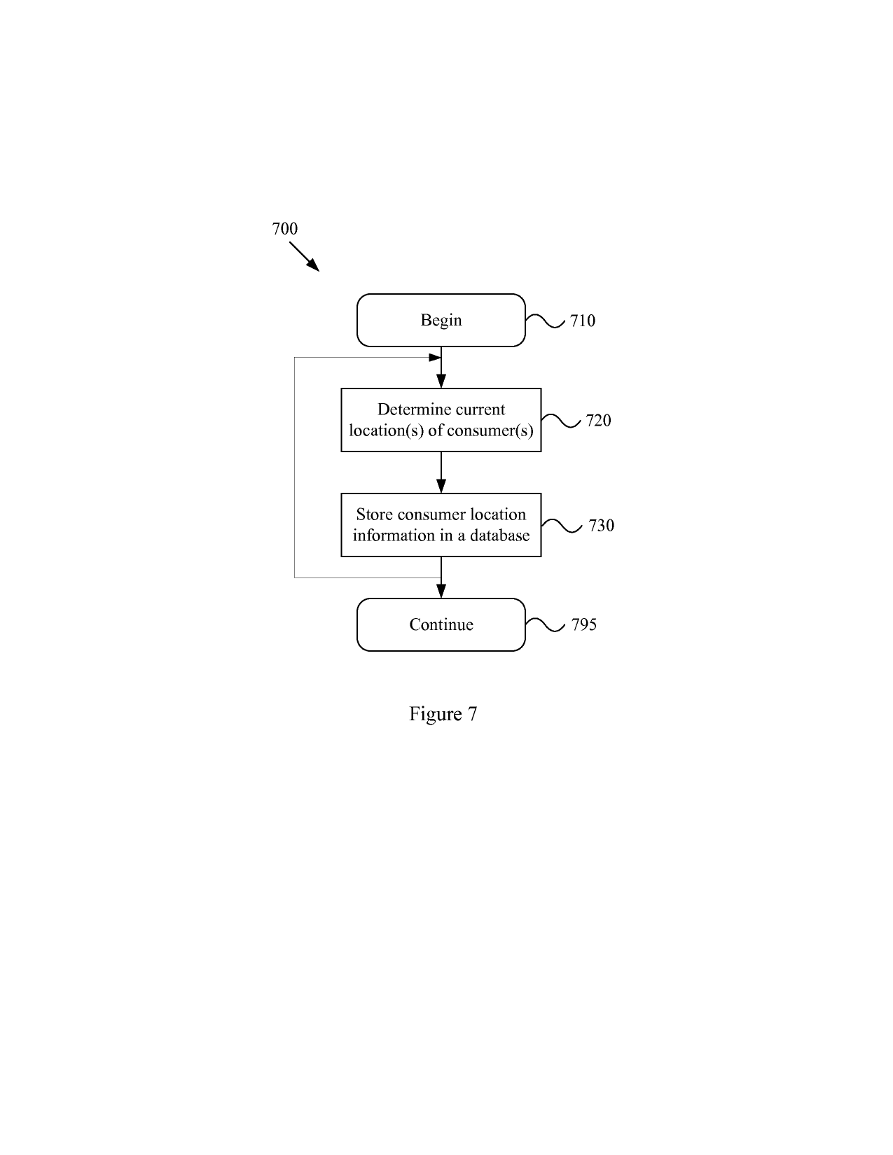

The example method 100 may, for example at step 120, comprise determining real-time present locations and/or predicted future locations for potential customers (e.g., mobile consumers). As will be explained later, for example in the discussion of FIG. 7 and elsewhere, such location determining may be performed in any of a variety of manners. For example, step 120 may comprise determining respective locations of potential customers by interacting with mobile devices carried by such potential customers, by interacting with a system with which customers' respective mobile devices are in communication, by interacting with potential customers via a user interface by which the customers may manually input present and/or future location information, etc. Much of the following discussion concerns the real-time location of mobile consumers. The characterization of a consumer as “mobile” does not necessarily mean that the consumer is presently in motion. In other words, a consumer that is presently stationary at a particular location (e.g., at a business establishment competing with the proprietor, at an entertainment venue, etc.) may still be considered mobile.

The example method 100 may, for example at step 130, comprise determining (or identifying) a proprietor that is within the vicinity of the determined customer location(s). As an example, the system, having identified that a potential customer is in a particular neighborhood, may search its database of participating proprietors to determine whether the potential customer is in the vicinity of one or more participating proprietors. For example, a proprietor may have previously expressed an interest in mobile consumers located within a particular distance of the proprietor's place of business. In such a scenario, step 130 may comprise identifying participating proprietors for which the mobile consumer's location meets proprietor-specified location criteria.

The example method 100 may, for example at step 140, comprise determining whether to provide promotion information from the proprietor to a potential customer based, at least in part, on profile or real-time information received from the proprietor. As an example, a proprietor may have previously indicated that promotion information be automatically (e.g., without further proprietor interaction) communicated to the customer (e.g., to a mobile device thereof) under particular circumstances. As another example, a proprietor may have previously specified that the system is to contact the proprietor under particular circumstances, for example for final proprietor approval and/or additional instructions, prior to communication of promotion information to potential customers that have been identified in a particular geographical region.

The example method 100 may, for example at step 150, comprise, if it was determined at step 140 to provide promotion information to one or more potential customers, communicating the promotion information (e.g., an offer of goods and/or services) to the one or more potential customers. As will be explained in more detail later, such communicating may, for example, comprise utilizing any of a variety of communicating methods (e.g., text-messaging, voice messaging, email messaging, MMS messaging, video messaging, etc.). Also, as explained later, step 150 may comprise determining the manner in which to communicate promotion information to the customer(s) based, at least in part, on a profile set up by the participating customer(s) and/or participating proprietor(s).

In general, FIG. 1 shows a non-limiting example flow diagram of a method 100 for communicating promotion content, in accordance with various aspects of the present invention. Accordingly, the scope of various aspects of the present invention should not be limited by particular characteristics of the example method 100 unless explicitly claimed.

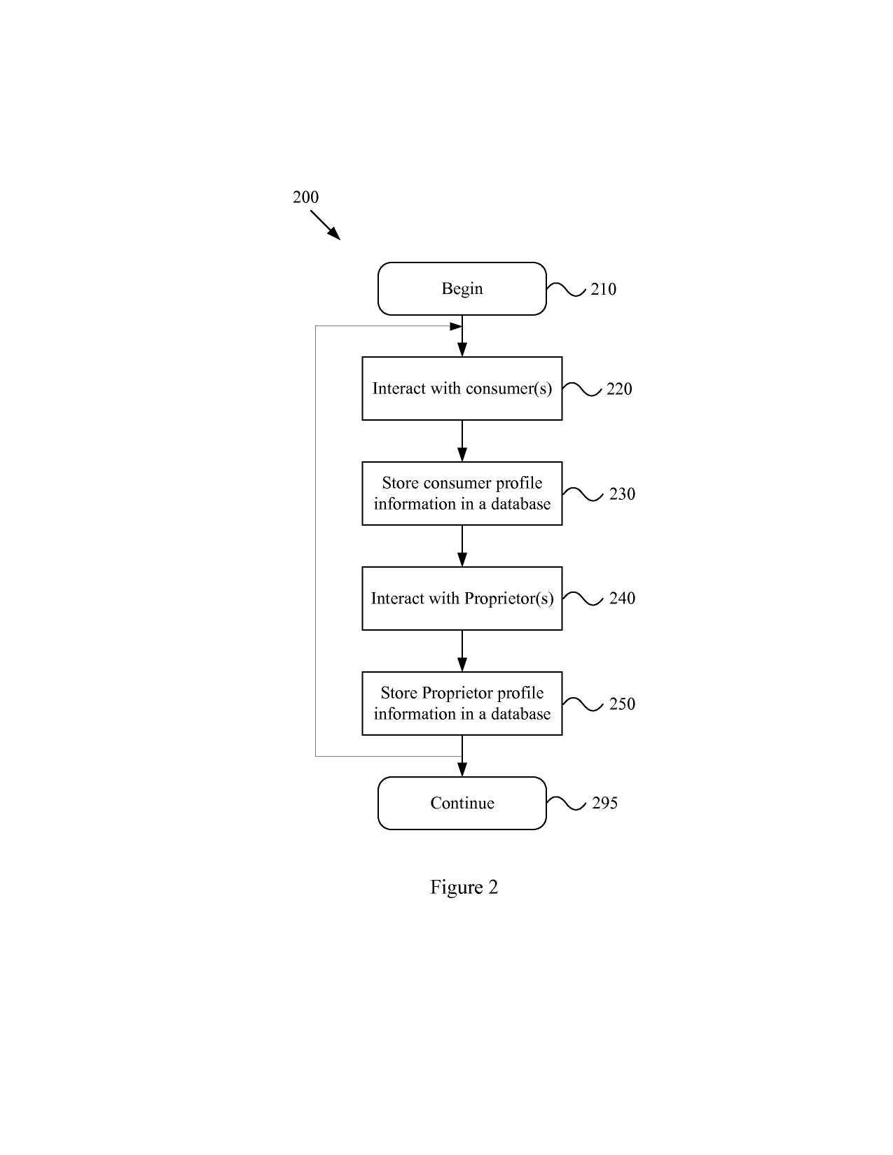

As mentioned above, various aspects of the present invention include interacting with users (e.g. potential customer users and proprietor users). Turning next to FIG. 2, such figure shows a non-limiting example flow diagram of a method 200 for interacting with users, in accordance with various aspects of the present invention. The example method 200 may, for example, share any or all characteristics with the example method 100 discussed previously.

The example method 200 begins executing at step 210. Such execution may begin for any of a variety of reasons, non-limiting examples of which will now be presented. For example, the method 200 may continually execute, for example continually looping through steps 220-250 or any other set of steps. Also for example, the method 200 may begin executing in response to a timer. Additionally, for example, the method 200 may begin executing in response to a proprietor and/or customer interacting with the system executing the method 200. Further for example, the method 200 may begin executing in response to detection of a particular set of initiating circumstances, for example detection of one or more customers and a participating proprietor in close proximity.

The example method 200 may, for example at step 220, comprise interacting with consumers (or potential consumers). Various non-limiting examples of such interaction were presented previously, and many additional non-limiting examples of such interaction will be presented below.

Step 220 may, for example, comprise providing a user interface, for example a graphical user interface, by which a system implementing the method 200 may interact with potential consumers, for example to define the nature of the system's interaction with such consumers, to define types of promotional offers in which such consumers are interested, to define criteria for the delivery of promotional offers to such consumers, etc. Many examples of such interaction will now be provided.

Step 220 may, for example, comprise interacting with a consumer (e.g., via a user interface provided to the consumer) to identify when the consumer is to be contacted. For example, a consumer may specify that the system may always contact (or attempt to contact) the consumer. For example, step 220 may provide a user interface feature allowing the consumer to turn the promotion-delivery service (or application thereof) on or off. For example, the consumer may specify that whenever a capable communication device of the user (e.g., a smart phone, notepad computer, laptop computer, cellular phone, automobile radio, etc.) is active, the system may interact with the consumer (e.g., providing location-based promotion information to the consumer, etc.). Additionally for example, the consumer may completely disable the system's interaction with the consumer, for example when the consumer has no present interest in receiving promotional information.

Step 220 may also, for example, comprising interacting with a consumer (e.g., via a user interface provided to the consumer) to define one or more time windows during which the consumer desires interaction with the promotion-delivery service. For example, the consumer may define a time window during which promotional information is desired. In an example scenario, a consumer that knows of an upcoming shopping or entertainment excursion may indicate a corresponding time window of such activity to the system implementing the method 200. The consumer may thus direct the promotion-delivery service to only provide promotional or advertising information (or particular types thereof) during such time window.

As another example, a consumer may indicate that whenever the consumer's communication device is connected to a communication service (e.g., an email service, an MMS service, a social networking service, a telephony service, an audio and/or video streaming service, etc.), the consumer is willing to accept promotion or advertising information.

As another example, a consumer may indicate that whenever the consumer's communication device is located within (or alternatively without) a particular geographical region (e.g., downtown), the consumer desires to receive promotional information from proprietors (e.g., proprietors within the geographical region, within a particular distance of the consumer, etc.).

As an additional example, step 220 may comprise interacting with a consumer (e.g., via a user interface provided to the consumer) such that a consumer may specify that the promotion-delivery system is only to interact with the consumer (e.g., communicating promotion information to the user) when the consumer explicitly activates the promotion-delivery service. For example, in an example scenario, when a consumer embarks on a night out, the consumer may activate the promotion service, which may then automatically track the consumer's location and provide directed promotional information to the user based, at least in part, on the consumer's present or anticipated location. Also for example, when a consumer (e.g., a potential customer of a proprietor) desires to receive promotion information for proprietorships in his/her vicinity, the consumer may explicitly command the system to provide the consumer with any promotional information from businesses in the vicinity of the user. For example, a consumer or consumer group may desire to change entertainment venues or find an initial entertainment venue, and then solicit advertising information regarding current real-time promotions from the system.

As a further example, step 220 may comprise interacting with a consumer (e.g., via a user interface provided to the consumer) such that the consumer may specify that the promotion-delivery system is only to communicate promotional information to the consumer when the consumer is identified by location as having left a home and/or work location. For example, the promotion-delivery service might be enabled (e.g., automatically or based on user response to a prompt) when the location identified for a user is different from a registered home location, a work location, any location generally not associated with consumer purchase activity, etc. Also for example, the promotion-delivery service might be enabled (e.g., automatically or based on user response to a prompt) when the location identified for a user is one that is pre-defined by a user as desirable for promotion interaction (e.g., within the confines or vicinity of a given building, mall, location, neighborhood, etc.).

As a still further example, step 220 may comprise interacting with a consumer (e.g., via a user interface provided to the consumer) such that the consumer may specify particular trigger conditions upon which the promotion-delivery service may communicate promotional information to the consumer. For example, a consumer may specify that the consumer is only to be contacted with promotion offers that meet and/or exceed a particular quality. For example, a potential consumer going out for dinner might indicate a desire to only be informed of dinner coupon offers of $20 off or better, drink specials at least as good as 2-for-1 drinks, etc.

Also, the consumer may specify that the consumer is only to be contacted regarding promotional information for goods and/or services in a particular geographical region, within a particular distance of the user, etc. For example, a consumer at a ball game or other venue might specify a desire to only receive promotional information corresponding to businesses (or even particular types of businesses) within a mile of the venue.

As mentioned previously, the consumer may specify a time window for receiving promotion information. The consumer may similarly, for example, define a time window associated with the validity period of promotions or advertisements. For example, the consumer may direct the promotion-delivery system to only provide promotion or advertising information that is relevant for a particular evening (e.g., either the present evening or an upcoming evening).

Step 220 may, for example, comprise interacting with a consumer (e.g., via a user interface provided to the consumer) such that the consumer may specify particular goods and/or services for which promotional information is desired. For example, the consumer may specify that the consumer is only to be contacted with promotion offers regarding a particular one or more goods and/or services (e.g., one or more on a “shopping list”). In an example scenario, step 220 may comprise providing a user interface that includes an enumerated list of goods and/or services from which the user can select goods and/or services of interest. Such an enumerated list may, for example, correspond exactly to an enumerated list presented to a proprietor of goods and/or services utilized to characterize the goods and/or services provided by a proprietor (e.g., utilized to specify particular goods and/or services associated with a promotion). In another example scenario, step 220 may comprise providing a goods and/or services search engine by which a consumer may search for particular goods and/or services of interest.

Step 220 may for example, comprise interacting with a consumer (e.g., via a user interface provided to the consumer) such that the consumer might define the manner(s) in which the location of the consumer shall be determined. For example, in an example scenario, a consumer might specify that the system track the exact location of the user (e.g., so that the system might provide the most geographically relevant promotional information to the consumer). In another example scenario, for example, a consumer might specify that the system is to generally track the consumer, but only at a relatively gross resolution (e.g., within a one hundred yard resolution, within a ¼ mile resolution, within a city block resolution, within the confines or vicinity of a given building, mall, location, and/or neighborhood, etc.). Such consumer might, for example, be able to maintain some degree of travel privacy while still utilizing the location-based promotion-delivery service.

Also for example, the consumer may specify the location-determining method to be utilized to determine the location of the user (e.g., satellite positioning system, cellular-based triangulation, cell location and association therewith, as a function of the respective locations and/or signal strengths of in-range networks, location of network to which the consumer's electronic device is presently communicatively coupled, network or server based positioning, etc.). Note that step 220 may comprise interacting with the consumers personal electronic device (e.g., smart phone, tablet computer, etc.) with or without present human interaction, to ascertain the device's location-determining capabilities and manner of obtaining location information from the device. Such assessment of capabilities may, for example, be utilized to provide user-selectable options to the user. For example, step 220 may survey the user's electronic device, ascertain that the electronic device is capable of three different manners of location determining, and present the user with a selectable list of the three different manners.

Additionally, for example, a consumer might specify that the location of the consumer is only to be determined, recorded, and/or reported when the user explicitly commands such operation. Further for example, a consumer might specify that the location of the consumer is only to be manually input by the consumer. For example, the consumer might identify a street address, street intersection, landmark, shopping mall, neighborhood, district, city, town, parish, etc. Also for example, the consumer might specify a location (e.g., by dropping a pin) on an electronic map. Such operation may, for example, be utilized by a consumer that is utilizing an electronic device and/or system without location-determination capability or that desires to participate in the promotion-delivery service without activating automatic location-determination capability.

Step 220 may, for example, comprise interacting with the consumer (e.g., via a user interface provided to the user) such that the consumer may control the communication of consumer identification information (e.g., information that may be communicated to businesses with a potential interest in directing promotional information to the consumer). For example, as discussed elsewhere herein, a proprietor may direct promotional information to regular (or VIP) customers that are in the vicinity of the proprietor's place of business, to potential new customers located in such vicinity for the purpose of introducing such customers to the business, etc. Consumer identification information may, for example, be utilized to determine whether VIP-type customers and/or potential new customers are in the vicinity, so that promotion formation may be directed to them (e.g., as desired by a proprietor). Step 220 may, for example, provide the consumer the flexibility of specifying whether to be specifically identifiable to a proprietor, whether to be identifiable by a randomly chosen number, etc.

Step 220 may also, for example, comprise interacting with the consumer (e.g., via a user interface provided to the user) such that the consumer may specify particular proprietors from which the consumer is interested in receiving promotional information in real-time about goods and/or services. For example, the consumer may identify favorite entertainment venues, clubs, restaurants, retail establishments, etc. In an example scenario, the consumer may categorize proprietorships into classes (e.g., best, mediocre, worst, etc.), each class corresponding to a different respective set of promotion delivery rules.

Additionally for example, step 220 may comprise interacting with the consumer (e.g., via a user interface provided to the user) such that the consumer may specify particular types of promotions, particular goods and/or services, particular proprietorships, etc., for which the consumer does not desire to receive promotional information. For example, the consumer may blacklist particular proprietors, services, goods, geographical regions, rating or ranking levels, etc.

Step 220 may additionally, for example, comprise interacting with a consumer (e.g., via a user interface provided to the user) such that the consumer may specify that he/she desires only to hear from enterprises that meet a particular quality rating or ranking or that meet a minimum quality rating or ranking (e.g., only from 3-star and above restaurants, etc.). Such a quality rating or ranking may, for example, be based on the consumer's own prior experiences, based on ratings or rankings provided by a specific rating company or professional, based on ratings maintained by the promotion-delivery service and based on reviews from other participating consumers, based on reviews of a trusted group or social group identified by the consumer, etc.

Step 220 may additionally, for example, comprise interacting with a consumer (e.g., via a user interface provided to the user) such that the consumer may specify the manner in which the consumer is to be contacted (e.g., regarding real-time location-based promotions). For example, the consumer may specify that the system is to interact with the user via text message, social networking message, email message, phone call and/or voice message, etc. Also for example, the consumer may specify a manner in which the consumer's electronic device is to notify the consumer, for example specifying ringer type and/or volume, repeat characteristics of notification (e.g., notify once or X times, notify repeatedly until the consumer responds, etc.), etc.

Various aspects of the present invention support the formation of groups. For example, step 220 may comprise interacting with one or more consumers (e.g., via a user interface provided to the user) such that the consumer(s) may specify or define a group (e.g., a real-time existing group) for the purpose of consuming particular common goods and/or services. For example, a one or more consumers may define a “bachelor party” group, a “birthday party” group, a “business lunch” group, a “ball game” group, etc. Alternatively (or additionally), the promotion delivery service may define an ad-hoc group by simply determining that a certain number of participants are currently near a given proprietor and interested in receiving promotion offers. In such scenarios, for example, a proprietor may determine, based on the size and location of such group, whether to extend a directed promotion or advertisement to such group (e.g., to each member thereof, to a designated leader thereof, etc.) regarding one or more goods and/or services specified or believed to be of interest to such a group or to such proprietor.

In an example scenario, a consumer group of individual consumers may be formed specifying that they are presently looking for an establishment at which to consume food and drinks after a game. In such a scenario, a proprietor may target a particular group and/or may target a series of groups (e.g., in a serial fashion) making an offer to each of a series of groups until the offer (or desired number of offers) is accepted. For example, a proprietor can sequence through “ball game” or “bachelorette party” groups, offering a promotion on a particular good and/or service until enough offers are accepted (e.g., purchased).

During formation or definition of a group, for example, a consumer may specify a group and identify the particular type(s) of promotion information in which the group is interested. Also for example, as part of a group specification (or on an individual consumer basis), a group may specify that the group desires particular terms for a promotional offer. For example, a group may specify that the group should not be contacted unless the offer is at least 2-for-1 drink specials, ¼ off the final bill, a particular dollar value for a good in which the group is immediately interested in purchasing, etc.

In a group-formation example, when a group has been formed, and the group's interests have been defined, and the group's location (present or future anticipated location based on user input and/or location history) has been determined, the system may solicit offers from proprietors regarding the group's interests. For example, when a group has been formed for a birthday celebration of a particular size, the system may contact proprietors and solicit offers on behalf of the group. In other words, there may be a present database of promotional offers searchable by the system and/or the system may solicit promotional offers based on present real-time consumer need. Alternatively (or additionally), for example, when a group has been formed, the group may simply solicit to receive, or receive without solicitation, promotion offers from and defined by one or more proprietors (e.g., to identify what the proprietor(s) are willing to offer to obtain the business of the group). In the case of multiple proprietors in this example, the proprietors compete with each other to present the best promotion offer to obtain the business of the group.

The consumer group-formation process may be integrated with any of a variety of social networking tools. For example, social networking group-defining mechanisms (e.g., friend groups) may be utilized to form buying groups that travel together. Additionally, consumers may utilize social networking tools to cause the formation of an impromptu group of individuals (e.g., a group of consumers that are all registered with the promotion-delivery service). Such formation of a group may then trigger delivery of a coupon or other promotional offer to the group of consumers. In an example scenario, a group may be formed in real-time (e.g., specified by a consumer, or identified by the promotion-delivery system), on an ad-hoc basis for example, and made up of participating consumers who may or may not already know each other, but have one or more common real-time interests and/or profiles, and that just happen to be at a particular location or in the vicinity of a particular proprietor at the same time. For example, consumers may have specified that they are interested in a certain promotion (e.g., “kids eat free” specials) or that they are interested in purchasing a certain product and/or service, and the system first identifies that a core group of those consumers are currently found at a particular location or within a particular vicinity, and then identifies those participating proprietors that are found at the same particular location or within the same particular vicinity (or vice versa). If a proprietor is interested (e.g., based on either pre-defined criteria or proprietor profile information or based on real time communication and confirmation between a proprietor and the system) in providing the consumer-specified promotion or offering a promotion on the specified product or service, then the promotion-delivery service communicates the offer of the promotion to each member of the group in real-time.

Step 220 may further, for example, comprise interacting with a consumer (e.g., via a user interface provided to the user) such that the consumer may rate (or access the ratings of) particular goods, services and/or proprietors. For example, consumers utilizing the promotion-delivery system may communicate regarding their experiences with particular proprietors (e.g., in particular with regard to utilization of the promotion-delivery service specified herein, with regard to general quality of goods/services, etc.). For example, step 220 may comprise providing a user interface by which users can select a general rating (e.g., a star rating), provide general or specific comments regarding experiences with a particular proprietor, etc.

Step 220 may comprise interacting with a consumer (e.g., via a user interface provided to the user) to specify one or more consumer profiles, each of which including any or all of the information discussed herein. Such a profile may then be utilized later by a consumer to efficiently specify present desired interaction with the promotion-delivery system. For example, a consumer may specify a “night out” profile, for example specifying that the consumer is interested in entertainment offers (e.g., drink, food, music, etc.). The consumer may then invoke the utilization of such a profile when desired. Similarly, a consumer may specify a “grocery shopping” profile, a “car shopping” profile, an “entertaining guests” profile, an “entertaining clients” profile, a “home electronics shopping” profile, etc., and then conveniently invoke the utilization of such profiles when desired. In an example scenario in which a consumer has previously defined multiple promotional profiles, step 220 may comprise providing a user interface feature by which the consumer may select one or more of such profiles.

Also for example, a promotion-delivery system may provide predefined profiles from which a consumer may select (e.g., a “night out” profile, a “ball game” profile, a “bachelor party” profile, an “electronics shopping” profile, a “client entertainment” profile, etc.).

As part of a consumer profile, a consumer may also define a distance or radius of interest from the consumer's present location. For example, a consumer that is on-foot may specify an interest of receiving only offers within a ½ mile distance from the user. A relatively mobile consumer may, for example, express an interest in receiving real-time promotions within a 5 mile radius of the user's present location, within a 5 mile radius of the user's home, etc. Such information may then be utilized by the system to filter out unwanted offers and may also be used by proprietors when making offers. For example, if a user is within the proprietor's offer envelope, but not within the customer's offer envelope, the proprietor or system can refrain from extending an offer to the customer. Similarly, if a potential customer is outside the proprietor's typical offer envelope, but has specified an interest in receiving offers within a radius or geographical region that includes the proprietor's location, the proprietor may be notified of such a condition and provided with an option to extend an offer (e.g., even though such an offer may violate a distance condition previously specified by the proprietor).

Step 220 may comprise providing a user interface by which the consumer may interact with the promotion-delivery system and/or proprietor regarding an offer provided to the consumer. For example, in an example scenario in which a consumer must accept and/or commit to a particular promotional offer, the system may provide a user interface by which the user may, express interest, provide a down payment, purchase an offered coupon, etc. In another example, the step 220 may comprise providing a user interface by which a consumer and/or representative of a consumer group may communicate a counter-offer back to an offering proprietor.

Step 220 may further comprise providing a registration interface, for example by which a consumer may register for utilization of the promotion-delivery service. Such registration may, for example, be free-of-charge, but may also be fee-based. In an example scenario, there may be different levels of membership at which a user may register, some of which may be free and some of which may be fee-based. As an example, a fee-paying consumer may be provided with promotional information at a higher priority than a non-fee-paying consumer. In another example scenario, a fee-paying consumer may be presented with no extra advertising (or less advertising) than non-fee-paying consumers. Membership in a group receiving the service may, for example, be subscription-based. Also for example, membership could be offered free for consumers that accept a particular number of offers per year.

Step 220 may additionally, for example, comprise providing navigation information to potential customers, such navigation information for example directing consumers to the proprietor's location. For example, a consumer may be presented with a user interface feature to trigger the promotion-delivery service (or a distinct mapping service) to provide navigation information (e.g., graphical and/or textual directions) to the consumer. Also for example, upon acceptance of an offer provided to a consumer, the system may automatically (e.g., without explicit user request) provide navigation information to the user. Such navigation information may, for example, comprise textual, graphical, and/or audio directions to the proprietorship. Such navigation information may also, for example, comprise information identifying alternative travel options for use by the consumer to travel to the proprietorship.

Step 220 may comprise interacting with a consumer (e.g., via a user interface provided to the user) to present promotional information to the consumer. Such interaction may be performed in any of a variety of manners, non-limiting examples of which will not be presented.

For example, step 220 may comprise presenting a promotional offer to the consumer displayed on a video display of a user's personal electronic device. Also for example, step 220 may comprise presenting the consumer with an offer to purchase a coupon. For example, upon receiving a location-based promotional offer from a proprietor, a user may purchase the official coupon (upon which the system may transfer monies for coupon and/or the provided good or service). In such an example, upon purchase of a coupon, step 220 may comprise communicating the official coupon (e.g., with barcode and/or other identifying information) to the consumer. Additionally, for confirmation purposes, notification information regarding the purchase may also be provided to the proprietor (e.g., for verification of a customer's coupon upon utilization thereof, for tracking number of promotional offers accepted, etc.).

In an example scenario, upon utilization of an electronic coupon that has been communicated to a user (e.g., as triggered by a proprietor), the coupon may be automatically verified, the consumer may receive the benefit of the coupon, and/or the proprietor and/or consumer may be charged.

In another example scenario, an electronic coupon may be provided to a consumer based at least in part on location of the consumer. An interface may then be provided to the consumer, for example for purchase of or reservation of an offered coupon before the offer expires. After purchase of the coupon the coupon may be communicated to the customer and/or activated if already communicated. Then the consumer may utilize the coupon at the proprietor's place of business, upon which the proprietor may verify and close out the coupon.

In yet another example scenario, step 220 may comprise presenting a potential consumer with a real-time offer having a relatively short expiration time. For example, a proprietor may specify that the promotional offer provided to the consumer is only valid for a relatively short time period (e.g., to address an immediate commercial interest of the proprietor in real-time). In such a scenario, step 220 may comprise communicating the offer to the user along with a count-down timer showing the amount of time that the user has to accept (e.g., purchase) the offer. In such a scenario, step 220 may also comprise communicating with the user regarding accepting or declining the offer, and may also communicate with the proprietor (e.g., in real-time) regarding such accepting or declining.

In an example scenario, a consumer may be provided with a software application (or a hyperlink to a central website). The consumer may, for example, execute such application whenever interested in receiving information from the promotion-delivery service, whenever the consumer desires to modify promotion or advertising delivery criteria, etc. In such a scenario, most or all of the step 220 interaction with the consumer may be performed on the consumer-end by execution of an application residing on an electronic device of the consumer (e.g., on the consumer's smart phone, tablet computer, laptop computer, personal digital assistant, etc.). Such an application may, for example, correspond to a counterpart application executing at a central location or regional office of the promotion-delivery service, executing on a computer of a proprietor, etc.

In general, step 220 comprises interacting with consumers (or potential consumers). Various non-limiting examples of such interacting were presented above. Such examples were provided by way of illustration and not limitation. Accordingly, the scope of various aspects of the present invention should not be limited by particular characteristics of such interacting unless explicitly claimed.

As discussed above with regard to step 220, the example method 200 may comprise interacting with consumers or potential consumers of goods or services regarding any one or more of a variety of different types of information. At least some of such information may, for example, be utilized to define consumer profiles (e.g., defining any of a variety of aspects of system operation as they pertain to a particular consumer or group thereof). The example method 200 may, for example at step 230, comprise storing such consumer profile information in a database.

Such a database may comprise any of a variety of characteristics. For example, such a database may be maintained in a central location or a set of primary locations. Also for example, such a database may be distributed in a network of regional nodes. Additionally for example, such a database may be maintained in respective individual components associated with each consumer. In such a scenario, a consumer profile database for a consumer may be maintained in a respective personal electronic device (e.g., a smart phone, notepad computer, desktop computer, home server, etc.) or set thereof, associated with such consumer.

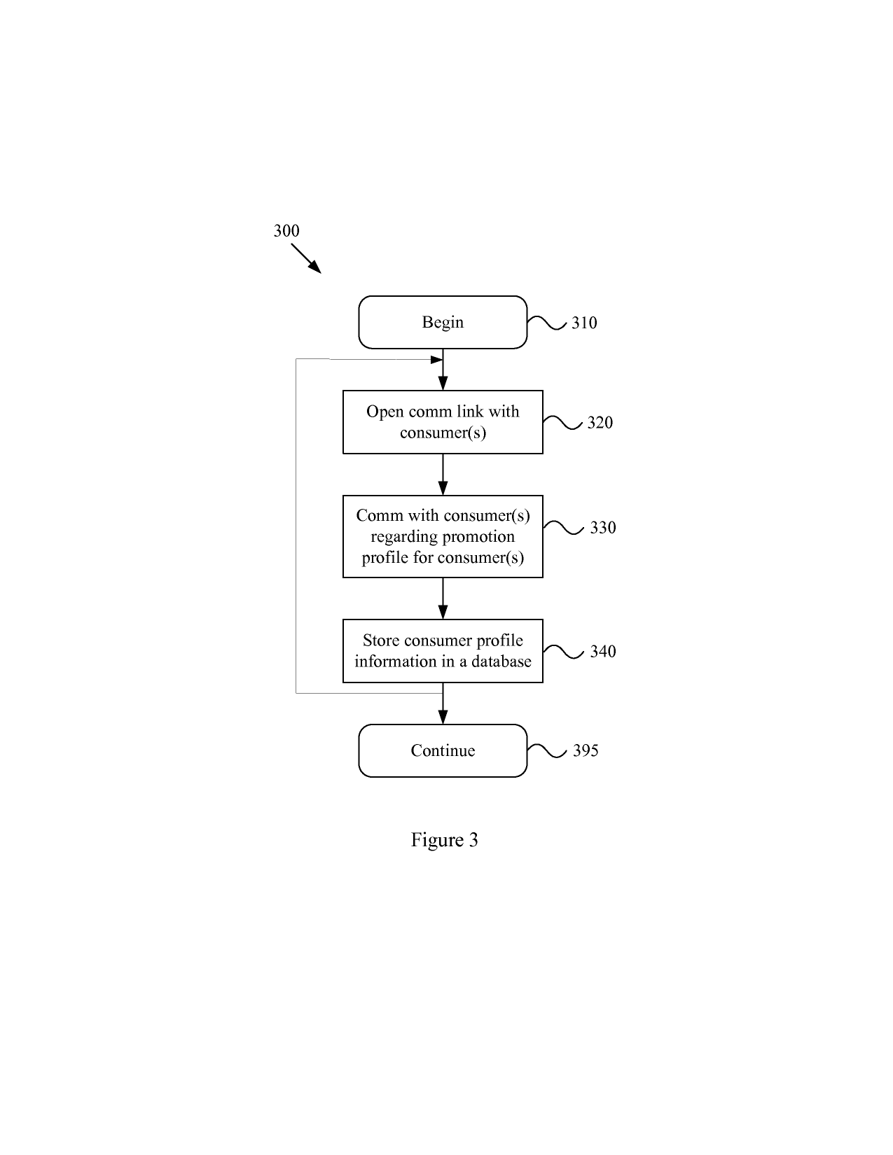

The previous discussion of steps 220 and 230 generally concerned interaction with potential consumers of goods or services. As discussed above, at least a portion of the communication with consumers at step 220 may comprise information that is maintained in one or more consumer profiles (e.g., stored in a database). Such operation, regarding the interaction with consumers regarding consumer profile information, is specifically illustrated by example in FIG. 3.

Referring now to FIG. 3, and returning to FIG. 2 later, FIG. 3 shows a non-limiting example flow diagram of a method 300 for interacting with consumers, in accordance with various aspects of the present invention. The exemplary method 300 may, for example and without limitation, share any or all characteristics with the exemplary methods 100-200 discussed previously and illustrated in FIGS. 1-2.

The example method 300 begins executing at step 310. Such execution may begin for any of a variety of reasons, non-limiting examples of which will now be presented. For example, the method 300 may continually execute, for example continually looping through steps 320-340 or any set of steps. Also for example, the method 300 may begin executing in response to a timer. Additionally, for example, the method 300 may begin executing in response to a customer interacting with a system executing the method 300 or a portion thereof. For example, a consumer may enter a user input indicative of a desire to input customer profile information.

The example method 300 may, for example at step 320, comprise opening a communication link with a consumer. Such a communication link may, for example, comprise a personal communication link involving only a user interface between the consumer and a personal electronic device of the consumer. Such a communication link may also, for example, comprise an electronic communication link between a consumer's personal electronic device and a central or regional system (e.g., via local area networks, via metropolitan area networks, via the Internet, via a telecomm network, via a cable network, via a satellite communication network, etc.).

The example method 300 may, for example at step 330, comprise interacting with a consumer regarding promotional profiles for the consumer. Many non-limiting examples of such interaction were presented previously, for example in the discussion of step 220. Accordingly, step 330 may share any or all characteristics with step 220, for example with regard to interacting with the consumer regarding any type of information that may be stored in a promotion profile for the consumer (e.g., interaction regarding identification of goods/services, location information, tracking information, consumer identification information, time-of-contact information, manner-of-contact information, group formation information, proprietor rating information, etc.).

The example method 300 may, for example at step 340, comprise storing the profile information in a database. Step 340 may, for example, share any or all characteristics with step 230 discussed previously.

After step 340, the execution of the example method 300 may, for example, loop back up to step 320 for continued consumer interaction. Alternatively for example, execution of the example method 300 may flow to the continued processing step 395. Such continued processing may comprise any of a variety of characteristics, many non-limiting examples of which are discussed herein. For example, such continued processing may comprise providing promotional information to the consumer, interacting with a proprietor regarding promotional information to be provided to consumers, determining whether to provide promotional information to a consumer, determining whether to contact a proprietor with a present promotional opportunity, etc.

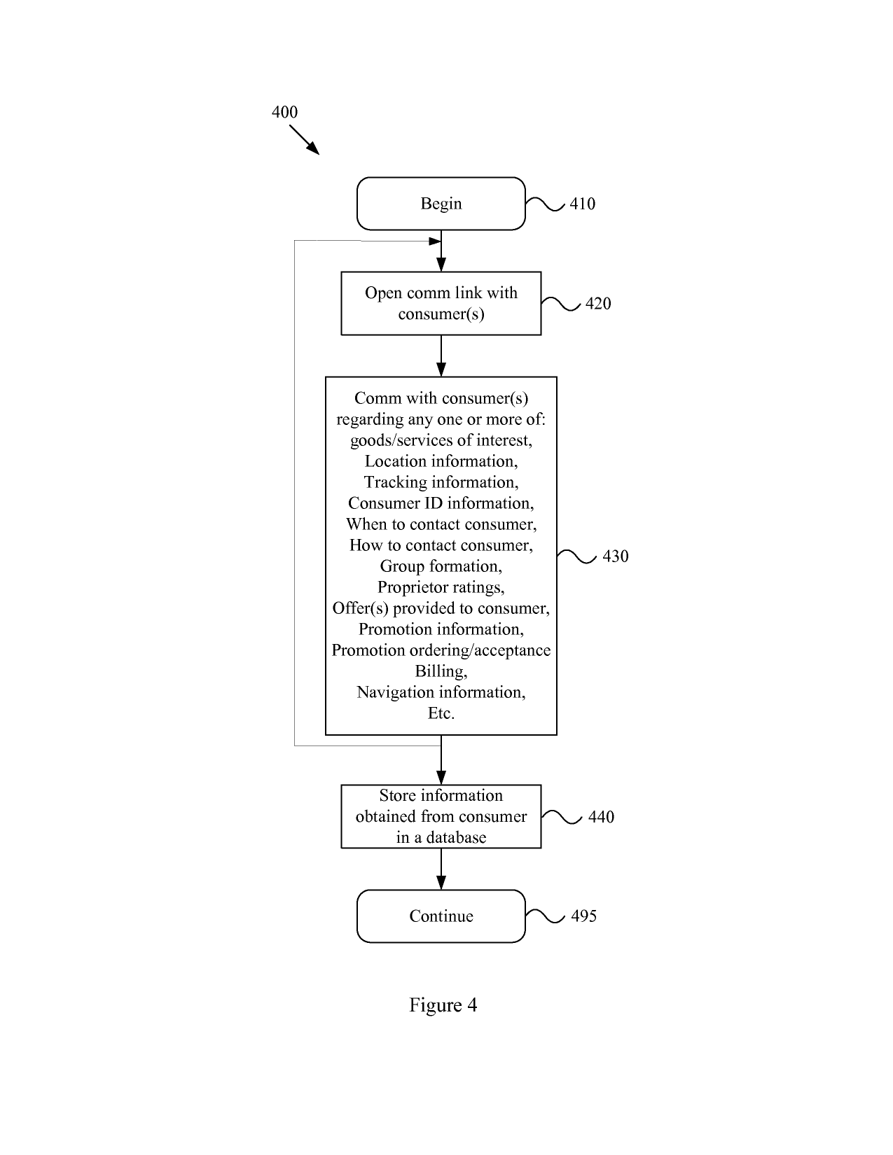

Referring back to FIG. 2, the previous discussion of steps 220 and 230 generally concerned interaction with a potential consumer of goods or services. As discussed above, at least a portion of the interaction with consumers at step 220 may regard information that is maintained in one or more consumer profiles (e.g., stored in a database of such profiles). Also as discussed above, at least a portion of the interaction with consumers at step 220 may regard information concerning promotional offers being communicated to the consumer. Such operation, concerning many of a variety of different types of information communicated with the consumer, is also illustrated in FIG. 4.

Referring now to FIG. 4, and returning to FIG. 2 later, FIG. 4 shows a non-limiting example flow diagram of a method 400 for interacting with consumers, in accordance with various aspects of the present invention. The exemplary method 400 may, for example and without limitation, share any or all characteristics with the exemplary methods 100-300 discussed previously and illustrated in FIGS. 1-3.

The example method 400 may begin executing at step 410. Such execution may begin for any of a variety of reasons, non-limiting examples of which will now be presented. For example, the method 400 may continually execute, for example continually looping through steps 420-430 (and/or 440) or any set of steps. Also for example, the method 400 may begin executing in response to a timer. Additionally, for example, the method 400 may begin executing in response to a customer interacting with the system executing the method 400. For example, a customer may enter a user input indicative of a desire to input customer profile information. Also for example, the system implementing various aspects of the present invention may determine to provide promotion information to the consumer. Additionally for example, such a system may determine to solicit information from the consumer regarding an outstanding promotional offer, regarding obtaining financial transaction information from the consumer, etc.

The example method 400 may, for example at step 420, comprise opening a communication link with a consumer. Step 420 may, for example, share any or all characteristics with step 320 discussed previously.

The example method 400 may, for example at step 430, comprise interacting with a consumer regarding any of a variety of different types of information, for example information concerning promotional profiles for the consumer, promotional offers being presented to the consumer, the manner in which the system is to interact with the consumer, financial information, etc. Many non-limiting examples of such consumer interactions were presented previously in the discussion of step 220. For example and without limitation, step 430 may comprise communicating with one or more consumers regarding goods/services of interest, location information, tracking information, consumer identification information, when to contact a consumer with a promotional offer, how to contact a consumer with a promotional offer, consumer group formation, rating proprietors, providing promotional offers to a consumer, receiving information from a consumer regarding a promotional offer that has been provided, billing and/or other financial transaction information, navigation information, etc.

After step 430, or alternatively after step 440, execution of the example method 400 may, for example, loop back up to step 420 for continued consumer communication.

The example method 400 may, for example at step 440, comprise storing consumer information in a database. Step 440 may, for example, share any or all characteristics with step 230 discussed previously.

After step 440, execution of the example method 400 may flow to the continued processing step 495. Such continued processing may comprise any of a variety of characteristics, many non-limiting examples of which are discussed herein. For example, such continued processing may comprise providing promotional information to the consumer, interacting with a proprietor regarding promotional information to be provided to consumers, determining whether to provide promotional information to a consumer, determining whether to contact a proprietor with a present promotional opportunity, etc.

The previous discussion of FIGS. 1-4 generally concerned various example aspects of a promotion-delivery system and/or method therefor in accordance with various aspects of the present invention. The various methods 100, 200, 300, 400 (e.g., consumer-related aspects thereof) may, for example, be performed by a processor executing software instructions. As a non-limiting example, a consumer may be provided with a software application (or a hyperlink to a central website, with which a consumer may interact utilizing a conventional web browser). The consumer may, for example, execute such application whenever interested in receiving information from the promotion-delivery service, whenever the consumer desires to modify promotion or advertising delivery criteria, etc. In such a scenario, most or all of the interaction with the consumer may be performed at the consumer-end by execution of an application residing on an electronic device of the consumer (e.g., on the consumer's smart phone, tablet computer, laptop computer, personal digital assistant, etc.).

For example, a consumer may download an App to a smart phone, and then run and stop the App whenever desired. Also for example, such a smart phone App may have a corresponding App that runs on a relatively larger computer (e.g., a desktop computer, laptop computer, notepad computer, etc.), for ease of interaction. Any changes to a user's profile, for example, may then be synchronized with a central networked computer and/or the user's smart phone or other portable device. Alternatively (or additionally), any of the functionality discussed herein may also be implemented at a central location, for example providing user interaction functionality via a general web browser application which may execute on a personal electronic device of the user.

Now referring back to FIG. 2, steps 220 and 230 discussed previously primarily concerned interaction with a consumer (or potential consumer) of goods and/or services, for example a recipient (or potential recipient) of a commercial promotion based, at least in part, on consumer location. Steps 240 and 250, to be discussed next, generally concern interaction with a proprietor of goods and/or services, for example a source (or potential source) of a commercial promotion provided based, at least in part, on consumer location.

The example method 200 may, for example at step 240, comprise interacting with proprietors, for example regarding promotional offer details, regarding targeted consumers for such promotional offers, etc. Various non-limiting examples of such interaction were presented previously, and many additional non-limiting examples of such interaction will be presented below.

Step 240 may, for example, comprise providing a user interface, for example a graphical user interface, by which a system implementing the method 200 may interact with proprietors to define the nature of the system's interaction with such proprietors and at least in part with potential consumers. Many examples of such interaction may now be provided.

Step 240 may, for example, comprise interacting with a proprietor (e.g., via a user interface provided to the proprietor) to define general goods and/or services for sale by the proprietor, for example to specify the nature of the particular product(s) and/or service(s) provided by the proprietor.

Step 240 may also, for example, comprise interacting with a proprietor (e.g., via a user interface provided to the proprietor) to define delivery conditions concerning if and/or when promotion information is to be provided to potential consumers automatically (e.g., without present real-time interaction with the proprietor). For example, step 240 may comprise interacting with a proprietor to determine when a promotional offer should be provided to consumers without further interaction with the proprietor.

For example, in an example scenario, step 240 may comprise interacting with a proprietor to set up delivery of an offer to a set of potential consumers within a particular radius of the proprietorship when such set of potential consumers reaches a threshold number that have specified an interest in receiving information regarding the particular product and/or service being offered by the proprietor. In another example scenario, step 240 may comprise interacting with a proprietor to specify that a particular promotional offer is to be provided to any consumer (or any consumer who has expressed an interest in the offered good/service) that enters a defined geographical area.

In yet another example scenario, step 240 may comprise interacting with a proprietor to define regular (e.g., temporally periodic, like daily or weekly) offers to communicate to potential customers on a periodic basis (e.g., at lunch hour, at a defined happy hour, etc.). In still another example scenario, step 240 may comprise interacting with a proprietor to specify that a promotional communication be communicated to consumers when a particular number of potential customers are detected at a particular location (e.g., when N or any number of consumers are detected at an entertainment venue, when N or any number of potential consumers are detected at or in the vicinity of a competitor's premises, when N or any number of potential consumers are detected at a location complementary or adjacent to a proprietor's business, etc.).

In still another example scenario, the promotion-delivery system may process customer location information to determine that a customer has just left a venue (e.g., a potential customer or customer group has just left a baseball stadium). In such a scenario, step 240 may have previously interacted with a proprietor to initiate automatic communication of promotional information regarding dining specials to potential customers leaving the venue. Note that in such a fully-automatic scenario, the system may then notify the proprietor of the promotional communication (e.g., by text, email, MMS, automated phone call, etc.) and/or acceptance of the promotional communication by one or more consumers.

Step 240 may also, for example, comprise interacting with a proprietor (e.g., via a user interface provided to the proprietor) to identify triggering conditions on which the system is to contact the proprietor (e.g., with regard to a real-time promotional opportunity based at least in part on consumer location). For example, step 240 may comprise interacting with a proprietor to specify that the proprietor is to be contacted by the system (e.g., in any of the manners discussed herein) when a particular number of consumers is nearby that have specified interest in a particular good and/or service provided by the proprietor. For example, in such a scenario, a proprietor, upon receiving a message from the system, may survey or consider the current business environment (e.g., number of current and/or expected customers, available goods and/or services, etc.) and determine whether to extend an offer (and if so, may determine what to offer and how long to offer it).

In an example scenario, a restaurant manager can survey the number of empty tables in the restaurant and determine whether to extend an offer to nearby potential customers, what the details of the offer should be, how many customers should be provided with the offer, how long the offer is valid, etc. In such example scenario, step 240 may, for example, comprise interacting with such restaurant manager with regard to such information.

In another example scenario, the proprietor may specify that the proprietor should only be contacted when a particular number of potential customers are within a particular distance of the proprietor's business establishment that have expressed an interest in the proprietor and/or its goods and/or services. In yet another example scenario, the proprietor may specify an interest in gatherings with particular professional and/or age profiles (e.g., teachers, lawyers, doctors, teenagers, mothers, seniors, etc.). In such example scenarios, step 240 may comprise interacting with such proprietor(s) regarding such information.

In scenarios involving contact with a proprietor, step 240 may comprise presenting the proprietor with information regarding the potential customer base. For example, a proprietor might direct the system to contact the proprietor when a potential customer base has achieved a particular size and/or a particular number of customers within a particular area (e.g., at one or more competitor establishments). For example, step 240 may comprise presenting a proprietor with a graphical map showing the location of potential consumers (e.g., consumers that have specified interest in the proprietor's goods and/or services). In such a scenario, for example in which a proprietor determines that a competitor is drawing many customers while the proprietor is not, the proprietor may target such competitor's customers with directed promotional offers that are superior to or different from those known to be provided by the competitor.

The system may, for example, have been previously directed to provide a proprietor with a recommended offer and, for example, to provide a user interface by which a proprietor may modify an offer, approve sending of the offer, etc. In such a scenario, step 240 may comprise performing such proprietor interaction.

Note that the proprietor may also specify whether present customers should be extended an offer as well. For example, the proprietor may determine to extend a present offer only to customers that are not presently located at the premises (e.g., to draw in additional customers, rather than reward those already present). Conversely, a proprietor may decide to extend an offer to present patrons, to reward them for their patronage and to entice them to stay. In such scenarios, step 240 may comprise performing such proprietor interaction (e.g., providing a user interface to the proprietor via which the proprietor can initiate the desired action).

As mentioned elsewhere herein, the system may solicit special offers on behalf of consumers or groups thereof (e.g., a real-time “flash” group of consumers). Step 240 may, for example, comprise interacting with a proprietor regarding such offers. A proprietor may, for example as part of the proprietor's profile, indicate whether the proprietor desires to receive such solicitations. Such functionality can, for example, be turned on and off by a proprietor (e.g., depending on present business conditions). Proprietors may also, for example, specify the conditions under which they desire to receive such solicitations (or not), for example specifying a minimum number of people in a group corresponding to such a solicitation.

As discussed elsewhere herein, the system (e.g., with interaction with the proprietor) may extend a promotional offer to a customer or series of customers, where the promotional offer is valid for only a limited period of time (e.g., an evening, an hour, a half-hour, 20 minutes, 15 minutes, 10 minutes, 5 minutes, etc.). In such a case, the system (e.g., at step 240 or the like) may contact the proprietor in real-time upon accepting (or declining) an extended offer. Such real-time interaction provides the proprietor the opportunity to react immediately to the real-time commercial environment (e.g., deciding to extend the offer to one or more other potential consumers, deciding to refrain from extending the offer again, deciding to modify the offer, deciding to resend a modified offer to the same consumer(s), deciding to extend the same offer to a next set of consumer(s), etc. Step 240 may comprise interacting with the proprietor regarding any or all of such decisions.

Step 240 may, for example, comprise interacting with a proprietor (e.g., via a user interface provided to the proprietor) to specify that the proprietor is to initiate interaction with the system. For example, a proprietor may register for the promotion-delivery service, but specify that the proprietor should not generally be contacted by the system/service, and that the proprietor is to initiate all transactions. In such a scenario, step 240 might, for example, only interact with the proprietor when the proprietor has logged into the system, executed an Application related to the system, performed some operation indicative of a desire to interact with the promotion-delivery system, etc.

For example, in an example scenario, a proprietor might determine that business at a restaurant or store is slower than desired and log into the system to identify whether there are consumers in the area interested in the restaurant's services or the store's products/services, or to identify participating consumers within the area whether or not such consumers have specified an interest in the restaurant's services or in the store's products/services. In such an example scenario, step 240 may comprise interacting with the proprietor such that the proprietor might specify that an offer be extended to the potential customers (e.g., to customers within a particular distance of the proprietorship who have expressed an interest in the good/service being provided, etc.).

In another example scenario, a proprietor may determine that business is slow and that a nearby ball game is a blowout or about to be concluded. In such a scenario, the proprietor may log into the system (for example, initiating execution of step 240) and extend an offer of drink specials to registered potential customers (e.g., consumers participating in the promotion delivery service) located at the game and then specify that the specials will only extend until the game is over or for some limited duration after the game concludes. Note that such a scenario may also apply to the automatic delivery option and/or interaction-with-the-proprietor options discussed above (e.g., a large discrepancy in game scoring or indication of near completion of the game may trigger automatic delivery of a promotional offer and/or trigger the system to initiate communication with the proprietor to notify the proprietor of the present promotional opportunity).

Step 240 may, for example, comprise interacting with a proprietor (e.g., via a user interface provided to the proprietor) to define aspects of immediate (or future) promotions to offer consumer(s). For example, step 240 may comprise interacting with a proprietor to define the good or service that is being offered, to define the offer that is to be made, to define the time duration of the offer, to define or specify a set of consumers to which an offer is to be provided, etc.

In an example scenario, a club manager can specify a 2-for-1 special to be offered for a particular period of time. In another example scenario, a restaurant manager can specify a “buy one, get the second half-off” special to be offered before 7:00 pm and after 10:00 pm. In yet another example scenario, an electronics store manager can specify a $100 discount deal for the first 10 people to purchase the deal (e.g., directing the system to sequence through a list of nearby customers until a desired number of offer acceptances occur). In such scenarios, step 240 may comprise performing all of the necessary interaction with the proprietor.

Promotions can also be predefined and stored. In such a scenario, step 240 may comprise interacting with a proprietor (e.g., via a user interface) to select from a plurality of predefined promotions. For example, upon a proprietor interacting with the system and indicating a desire to communicate a promotional offer to potential consumers, step 240 may comprise presenting the proprietor with a list of predefined promotions (e.g., coupons or discounts) from which the proprietor may select. Such predefined promotions may be generically defined for many proprietors and/or may for example have been previously defined by the particular proprietor (e.g., at step 240).

As discussed elsewhere herein, the proprietor may specify a number of offers that may be accepted. For example, a proprietor may tell the system to cycle through the targeted consumers until a particular number of offers have been accepted. In such a scenario, step 240 may comprise performing such interaction with the proprietor.

In an example scenario, a restaurant manager may have four empty tables for a 7:00 reservation. In such a scenario, the manager may direct the system to extend a promotional offer tied to the 7:00 reservation until four of such offers are accepted. Also for example, continuing the example scenario, the manager may direct the system to contact him/her as each offer is accepted (e.g., to monitor the status of the promotional offer in real-time). Additionally for example, continuing the example scenario, the manager may direct the system to contact him/her after a time period (e.g., after 20 minutes) with the status of the promotional offer (e.g., communicating the number of acceptances to the manager). In such a scenario, the manager may then react in real-time to determine whether to offer better terms, cancel the offer, etc. Further for example, continuing the example scenario, the system may provide an interface by which the manager may cancel the offer immediately in response to real-time conditions. For example, tables may fill unexpectedly, other patrons may stay longer then expected, etc. In such a scenario, step 240 may comprise performing any or all of the related interaction with the manager.

As discussed above, various aspects of the present invention may provide for offer/counter-offer interaction between consumers and proprietors. For example, a consumer and/or a consumer representing a group of consumers may communicate back to a proprietor regarding a counter-offer (e.g., looking for a better deal in exchange for the consumer's and/or consumer group's business). In such a scenario, the system (for example at step 240) may interact with the proprietor to present the counter-offer to the proprietor for acceptance, refusal, specification of a counter-counter-offer, etc.

Step 240 may, for example, comprise providing tracking information to a proprietor regarding the location of consumers that have accepted an offer. For example, a proprietor may monitor the location of consumers that have accepted an offer to determine whether such consumers are on their way (e.g., to determine whether to extend an offer to other consumers who have not yet received an offer).

As discussed elsewhere herein, various aspects of the present invention relate to billing, either consumer billing and/or proprietor billing. Step 240 may, for example, comprise interacting with a proprietor regarding such billing. Such billing-related interaction may comprise any of a variety of characteristics. For example, step 240 may comprise providing various billing options to the proprietor. For example, step 240 may comprise interacting with a proprietor regarding a blanket subscription (e.g., use as often as desired for a particular periodic fee, lifetime membership, etc.). Also for example, step 240 may comprise interacting with a proprietor regarding payment of a fee for unlimited use of the promotion-delivery system or for a particular limited amount of use.

A proprietor may be billed on a per-use basis. For example, a proprietor may, for example, pay a fee for every instance of use (e.g., regardless of a number of promotional offers sent out or number of promotion offers accepted or used). Also for example, a proprietor may be billed on a per-promotion basis (e.g., per single set of promotions, per promotional offer, etc.). For example, a proprietor may pay a fee for every coupon (or offer) that is communicated to a user. For example, a proprietor (e.g., at step 240) may specify that N number of offers be sent out, paying a particular fee for such N number of offers being sent. In such a scenario, volume discounts may be provided to the proprietor.

Also for example, a proprietor may pay a fee on the basis of number of promotions accepted. For example, in a scenario in which a potential customer is offered a coupon for purchase, such purchase may be managed and/or tracked by the system, and the appropriate monies transferred (e.g., from the user's purchase and/or from an account of the proprietor) to the system operator upon consumer purchase of a coupon. Billing may also be managed for financial transactions between the consumer and the proprietor.

Additionally for example, a proprietor may be billed by the promotion-delivery service based on a number of promotions (e.g., coupons) utilized. For example, in a scenario in which a customer need not purchase a coupon to utilize such coupon, ultimate utilization of the coupon by consumers may be tracked, and the appropriate monies transferred from the proprietor to the system operator upon consumer utilization of a coupon. For example, the notification (e.g., appearing on a display of a smart phone) may be utilized to obtain the offer (e.g., by containing a hyperlink, network address, file address, etc.). In another example, a coupon presented to a consumer on a display may, for example, be activated by the consumer (e.g., at step 220) or proprietor (e.g., at step 240), such activation being utilized to initiate a billing event. In such a scenario, a proprietor may thus be billed in proportion to the success of the offer.

Further for example, a proprietor may be billed based on a number of solicited consumers entering the proprietor's premises. For example, since the system may be tracking consumer location, the system may determine (e.g., after providing an offer to a customer) whether a consumer has subsequently entered the premises of the proprietor offering the deal. In another aspect, such tracking may be utilized by the system operator to ensure integrity of the system (e.g., used for detecting when a proprietor may be underreporting use of such coupons, when consumers might be replicating coupons, etc.).

Still further for example, promotion billing may also be performed in a multi-tier manner. For example, as explained elsewhere herein, utilization of a coupon may include a plurality of stages. In such a scenario, billing may likewise proceed in stages. For example, a first stage of billing may occur upon purchase of the coupon by a consumer, and a second stage of billing may occur upon utilization of the purchased coupon by the consumer at the proprietor's place of business. In an example scenario, at least a portion of the consumer's purchase monies may be collected by the system when a consumer purchases the coupon, and another fee may be collected from the proprietor upon utilization of the coupon at the proprietor's establishment.

As discussed above with regard to the consumer, the proprietor may also be provided with one or more software applications to reside on one or more computers of the proprietor. For example, the proprietor may be provided with a smart phone application, which may be wirelessly synchronized to a desktop computer, laptop computer, notepad computer, or other personal computer(s) in real-time. Such an application may, for example, provide for interaction with the proprietor in real-time. Thus, a manager on the floor and in touch with the real-time business environment may react quickly to manage the real-time promotional offers being communicated to potential consumers.

The previous discussion provided many non-limiting examples of proprietor interaction that may be performed by the method 200 (or by a system implementing the method 200). In general, step 240 may comprise interacting with a proprietor. Accordingly, the scope of various aspects of the present invention should not be limited by characteristics of any particular manner of proprietor interaction unless explicitly claimed.

As discussed above with regard to step 240, the example method 200 may comprise interacting with proprietors of goods or services regarding any one or more of a variety of different types of information. At least some of such information may, for example, be utilized to define proprietor profiles (e.g., defining any of a variety of aspects of promotion-delivery system operation as they pertain to a particular proprietor). The example method 200 may, for example at step 250, comprise storing such proprietor profile information in a database.

Such a database may comprise any of a variety of characteristics. For example, such a database may be maintained in a central location or a set of primary locations. Also for example, such a database may be distributed in a network of regional nodes. Additionally for example, such a database may be maintained in respective individual components associated with each proprietor. In such a scenario, a proprietor profile database for a proprietor may be maintained in a respective personal electronic device (e.g., a smart phone, notepad computer, etc.) or set thereof, associated with such proprietor or related proprietorship.

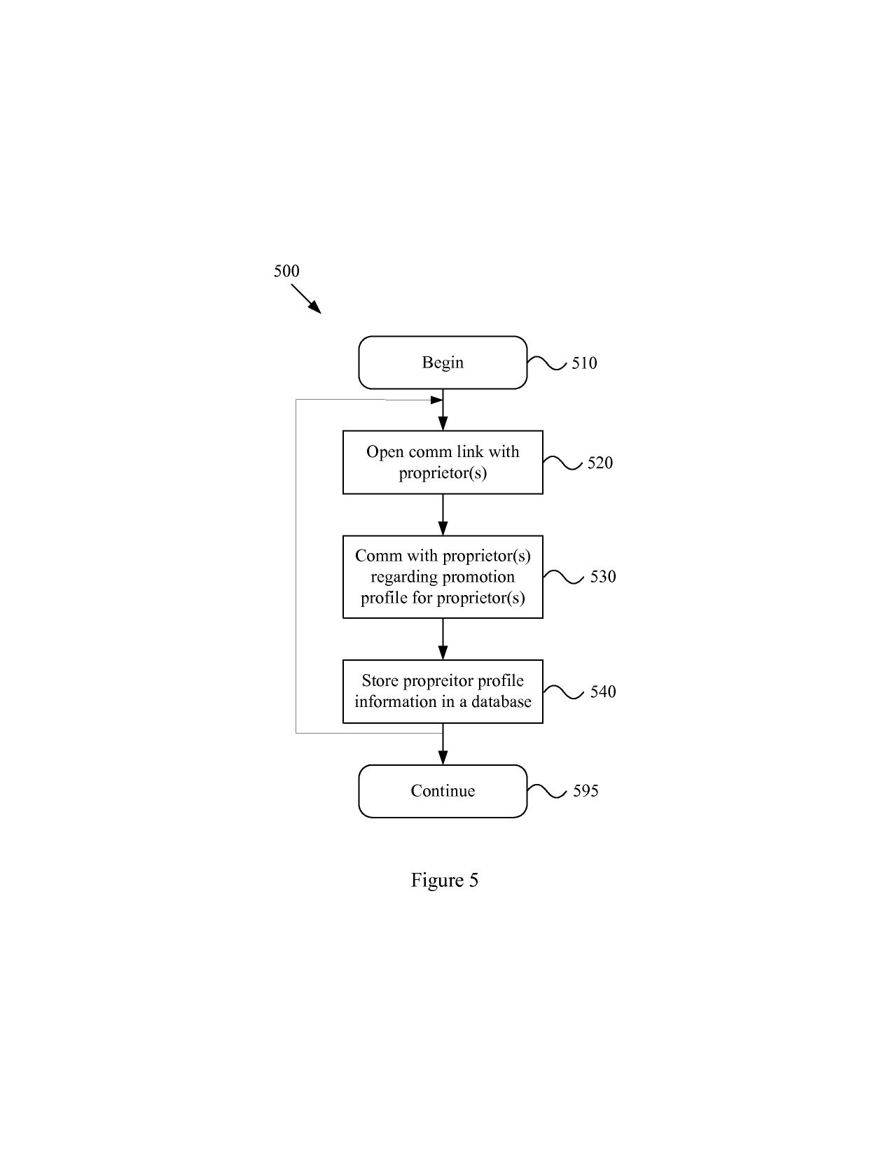

The previous discussion of steps 240 and 250 generally concerned interaction with proprietors of goods or services. As discussed above, at least a portion of the communication with proprietors at step 240 may comprise information that is maintained in one or more proprietors' profiles (e.g., stored in a database). Such operation, regarding the interaction with proprietors regarding profile information, is specifically illustrated in FIG. 5.

Referring now to FIG. 5, such figure shows a non-limiting example flow diagram of a method 500 for interacting with proprietors, in accordance with various aspects of the present invention. The method 500 may, for example and without limitation, share any or all characteristics with the exemplary methods 100-400 discussed previously and illustrated in FIGS. 1-4.

The example method 500 may begin executing at step 510. Such execution may begin for any of a variety of causes or conditions, non-limiting examples of which will now be presented. For example, the method 500 may continually execute, for example continually looping through steps 520-540, or any other sequence of steps. Also for example, the method 500 may begin executing in response to a timer. Additionally, for example, the method 500 may begin executing in response to a proprietor interacting with the system executing the method 500. For example, a proprietor may enter a user input indicative of a desire to input proprietor profile information.

The example method 500 may, for example at step 520, comprise opening a communication link with a proprietor. Such a communication link may, for example, comprise a local communication link involving only a user interface between the proprietor and a personal electronic device of the proprietor. Such a communication link may also, for example, comprise an electronic communication link between a proprietor's personal electronic device and a central or regional system (e.g., via local area networks, via metropolitan area networks, via the Internet, via a telecomm network, via a cable network, via a satellite communication network, etc.).

The example method 500 may, for example at step 530, comprise interacting with a proprietor (for example, a business manager and/or owner) regarding promotional profiles for the proprietor. Many non-limiting examples of such interaction were presented previously, for example in the discussion of step 240. Accordingly, step 530 may share any or all characteristics with step 240, in particular with regard to interacting with a proprietor regarding any type of information that may be stored in a promotion profile for the proprietor (e.g., interaction regarding identification of goods/services, location information, proprietor identification information, when and/or how to contact a proprietor, promotional offer characteristics, whether and/or when to communicate a promotional offer, consumer targeting information, counter-offer interaction, billing interaction, etc.).

The example method 500 may, for example at step 540, comprise storing the profile information in a database. Step 540 may, for example, share any or all characteristics with step 250 discussed previously.

After step 540, the execution of the example method 500 may, for example, loop back up to step 520 for continued proprietor interaction. Alternatively for example, execution of the example method 500 may flow to continued processing at step 595. Such continued processing may comprise any of a variety of characteristics, many non-limiting examples of which are discussed herein. For example, such continued processing may comprise providing promotional information to one or more consumers, interacting with a proprietor regarding promotional information to be provided to consumers, interacting with a proprietor regarding offer/counter-offer information, interacting with a proprietor regarding utilization of a promotional offer by a consumer, interacting with a proprietor regarding billing, etc.

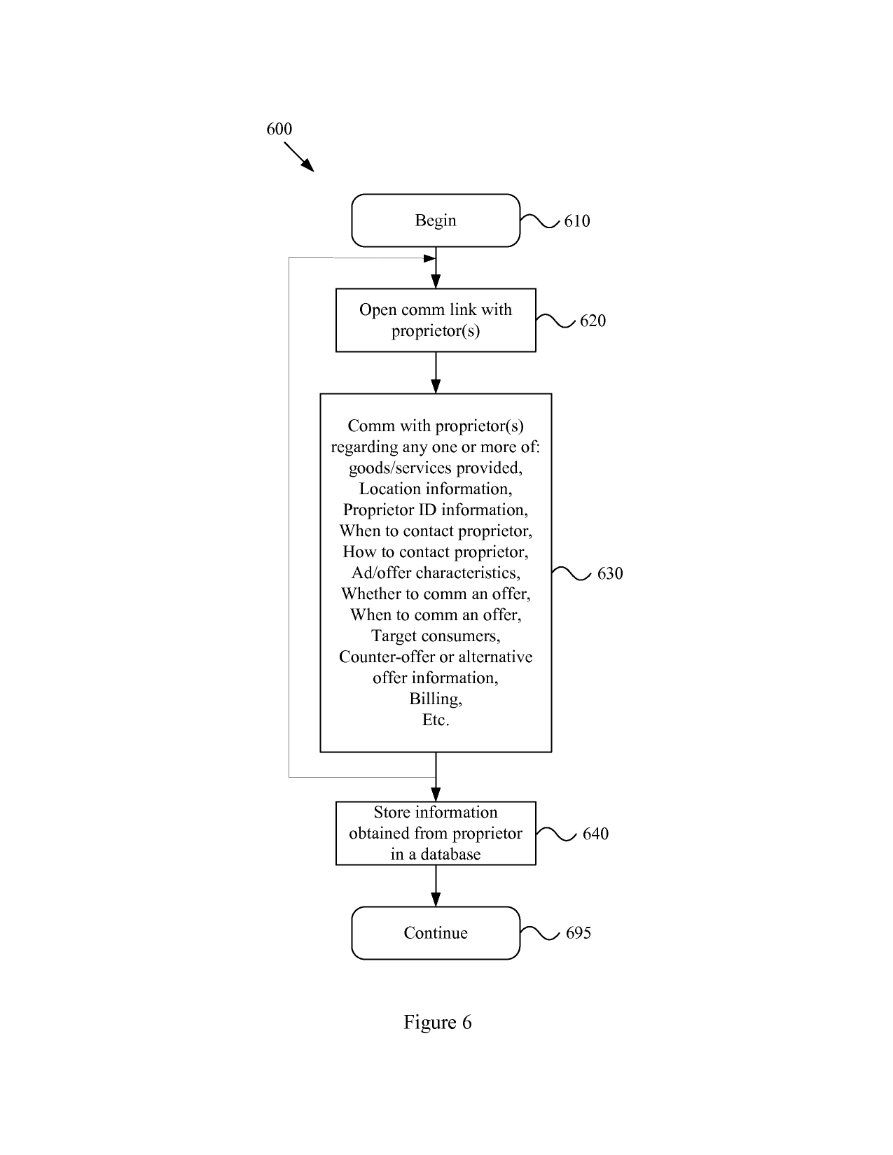

Referring back to FIG. 2, the previous discussion of steps 240 and 250 generally concerned interaction with a potential proprietor of goods or services. As discussed above, at least a portion of the interaction with the proprietor at step 240 may regard information that is maintained in one or more proprietor profiles (e.g., stored in a database of such profiles). Also as discussed above, at least a portion of the interaction with proprietors at step 240 may regard information concerning promotional offers being offered by a proprietor. Such operation, concerning many of a variety of different types of information communicated with the proprietor, is also illustrated in FIG. 6.

Referring now to FIG. 6, such figure shows a non-limiting example flow diagram of a method 600 for interacting with proprietors, in accordance with various aspects of the present invention. The method 600 may, for example and without limitation, share any or all characteristics with the exemplary methods 100-500 discussed previously and illustrated in FIGS. 1-5.

The example method 600 begins executing at step 610. Such execution may begin for any of a variety of reasons, non-limiting examples of which will now be presented. For example, the method 600 may continually execute, for example continually looping through steps 620-630 (and/or 640), or any other sequence of steps. Also for example, the method 600 may begin executing in response to a timer. Additionally, for example, the method 600 may begin executing in response to a proprietor interacting with the system executing the method 600. For example, a proprietor may enter a user input indicative of a desire to input proprietor profile information. Also for example, the system may determine to communicate promotion information with the proprietor. Additionally for example, the system may determine to communicate information with the proprietor regarding a current or planned promotional offer, regarding obtaining financial transaction information from the proprietor, etc.

The example method 600 may, for example at step 620, comprise opening a communication link with a proprietor. Step 620 may, for example, share any or all characteristics with step 520 discussed previously.

The example method 600 may, for example at step 630, comprise interacting with a proprietor regarding any of a variety of different types of information, for example information concerning promotional profiles for the user, promotional offers being presented to a consumer, the manner in which the system is to interact with the proprietor, financial information, etc. Many non-limiting examples of such proprietor interactions were presented previously in the discussion of step 240. For example and without limitation, step 630 may comprise communicating with one or more proprietors regarding identification of goods/services, location information, proprietor identification information, when and/or how to contact a proprietor, promotional offer characteristics, whether and/or when to communicate a promotional offer to a consumer, consumer targeting information, counter-offer information, billing information, etc.).

After step 630, or alternatively after step 640, the execution of the example method 600 may, for example, loop back up to step 620 for continued proprietor communication.

The example method 600 may, for example at step 640, comprise storing proprietor information in a database. Step 640 may, for example, share any or all characteristics with step 250 discussed previously.

After step 640, execution of the example method 600 may flow to continued processing step 695. Such continued processing may comprise any of a variety of characteristics, many non-limiting examples of which are discussed herein. For example, such continued processing may comprise providing promotional information to the consumer, interacting with a proprietor regarding promotional information to be provided to consumers, etc.

The previous discussion of FIGS. 1, 2, 5, and 6 generally concerned various aspects of interaction with a proprietor. The various methods 100, 200, 500, 600 (e.g., proprietor-related aspects thereof) may, for example, be performed by a processor executing software instructions. As a non-limiting example, a proprietor may be provided with a software application (or a hyperlink to a central website, with which a proprietor may interact utilizing a conventional web browser). The proprietor may, for example, execute such application whenever interested in interacting with the promotion-delivery service, whenever the proprietor desires to modify promotion or advertising delivery criteria, etc. In such a scenario, most or all of the interaction with the proprietor may be performed at the proprietor's end by execution of an application residing on a device of the proprietor (e.g., on the proprietor's smart phone, tablet computer, laptop computer, personal digital assistant, etc.).

For example, a proprietor may download an application to a smart phone, and then run and stop the application whenever desired. Also for example, such a smart phone application may have a corresponding application that runs on a relatively larger computer (e.g., a desktop computer, laptop computer, notepad computer, etc.) for ease of interaction. Any changes to a user's profile, for example, may then be synchronized with a central networked computer and/or the user's smart phone or other portable device.

Now referring back to FIG. 2, after step 250, execution of the example method 200 may flow to continued processing step 295. Such continued processing may comprise any of a variety of characteristics, many non-limiting examples of which are discussed herein. For example, such continued processing may comprise providing promotional information to the consumer, interacting with a proprietor regarding promotional information to be provided to consumers, flow to and/or from any other method step discussed herein, etc.

As discussed previously, various aspects of the present invention comprise determining and/or making promotional content delivery decisions based, at least in part, on consumer location (e.g., current location, last known location, anticipated next location, etc.). The determination of consumer location will now be discussed. FIG. 7 shows a non-limiting example flow diagram of a method 700 for tracking consumer location, in accordance with various aspects of the present invention.

The example method 700 may, for example at step 710, begin executing. The method 700 may begin executing for any of a variety of reasons, non-limiting examples of which will now be provided. For example, the method 700 may begin executing in response to another method (e.g., method 100 at step 120) having a need for consumer location information. Also for example, the method 700 may begin executing in response to user command (e.g., a consumer command to determine the consumer's location, a proprietor's command to ascertain respective locations of nearby consumers, etc.). Further for example, the method 700 may begin executing periodically and/or on a continually looping basis such that up-to-date consumer location information is available on demand. In general, the example method 700 may begin executing in response to any of a variety of causes and/or conditions.

The example method 700 may, for example at step 720, comprise determining a current location of one or more consumers. Step 720 may comprise determining consumer location in any of a variety of manners, non-limiting examples of which will now be provided.

For example, step 720 may comprise executing and/or interfacing with a local location-determining application on a consumer device (e.g., a personal communication device, smart phone, etc.). Such a local location-determining application may then communicate determined location information to a central system location (e.g., to a customer tracking module) for processing. As another example, a local application executing on a consumer's device may interface with communication infrastructure apparatus (e.g., portions of a cellular network, local area network, etc.) to ascertain the location of the customer device. Such a local application may then communicate the location information to a central system location (e.g., to a customer tracking module) for processing.

Timing regarding the communication of consumer location information to the system (e.g., to a system module implementing step 720) may vary. Such communication may, for example, occur periodically, upon a detected change in location, upon customer command, upon system command (e.g., requesting location information from a customer device), etc. In another example, step 720 may (e.g., periodically or in response to any triggering event) comprise contacting communication services providers (e.g., cellular telecommunication providers) for information of the location of consumer devices associated with a customer that has registered for the promotion-providing service. Step 720 may thus, for example, comprise receiving location information from networks providing services (e.g., communication services) to customer devices. For example, as part of a customer registration process, the system (e.g., a consumer tracking module) may interact with the consumer and/or a commercial enterprise providing services (e.g., communication services) to the consumer to define the manner in which the system will obtain location information for the consumer. The location information may, for example, comprise information of geographical coordinates, street address information, cell location information, etc.

Also, for example, step 720 may comprise receiving location information from consumer users. For example, as mentioned previously, a consumer may manually enter location information, for example utilizing the user interface capabilities of the consumer's personal electronic device. Such information may, for example, comprise address information, geographical coordinates, intersection information, neighborhood information, business name, landmark name, venue name, etc. Such information may then be communicated to the system (e.g., a central location thereof).

Additionally, for example, step 720 may comprise processing previously-received location information to predict a future location. For example, based on a plurality of location points and times, a linear or non-linear predictive algorithm may be utilized to predict a future location, for example at a particular time. In an example scenario, a predicted future location may be utilized to determine whether to extend a promotional offer to a consumer. For example, though a consumer might not presently be near a proprietor's location, movement of the consumer toward the proprietor's location (or an anticipated future location of the consumer near the proprietor's location) may be utilized by the proprietor and/or promotion-delivery system to determine whether to communicate a promotional offer to the user.

The example method 700 may, for example at step 730, comprise storing consumer location information in a database. Such a database may comprise any of a variety of characteristics, examples of which are presented elsewhere herein. For example, such a database may be centralized or may be distributed regionally. Also for example, such a database may be distributed among proprietors with each proprietor maintaining a local database of potential consumer locations. Further for example, such a database may be distributed among consumers, with each consumer maintaining an individualized location database which may, for example, be readily accessible by a system implementing various aspects of the present invention described herein.

In general, the example method 700 provides a non-limiting example of a method for tracking consumer location. Accordingly, the scope of various aspects of the present invention should not be limited by characteristics of any particular method of determining and/or tracking consumer location unless explicitly claimed.

The previous discussions generally addressed interaction with consumers and proprietors in accordance with various aspects of the present invention. Such interaction, for example, comprises interacting with consumers and/or proprietors regarding the manner in which a system implementing various aspects of the present invention will interact with such consumers and/or proprietors.

As mentioned previously, a proprietor may specify automatic system operation (e.g., system/method operation without real-time present proprietor input) or operation involving interaction with a proprietor during the promotion-providing process. Each of such modes of operation will now be demonstrated by respective non-limiting examples.

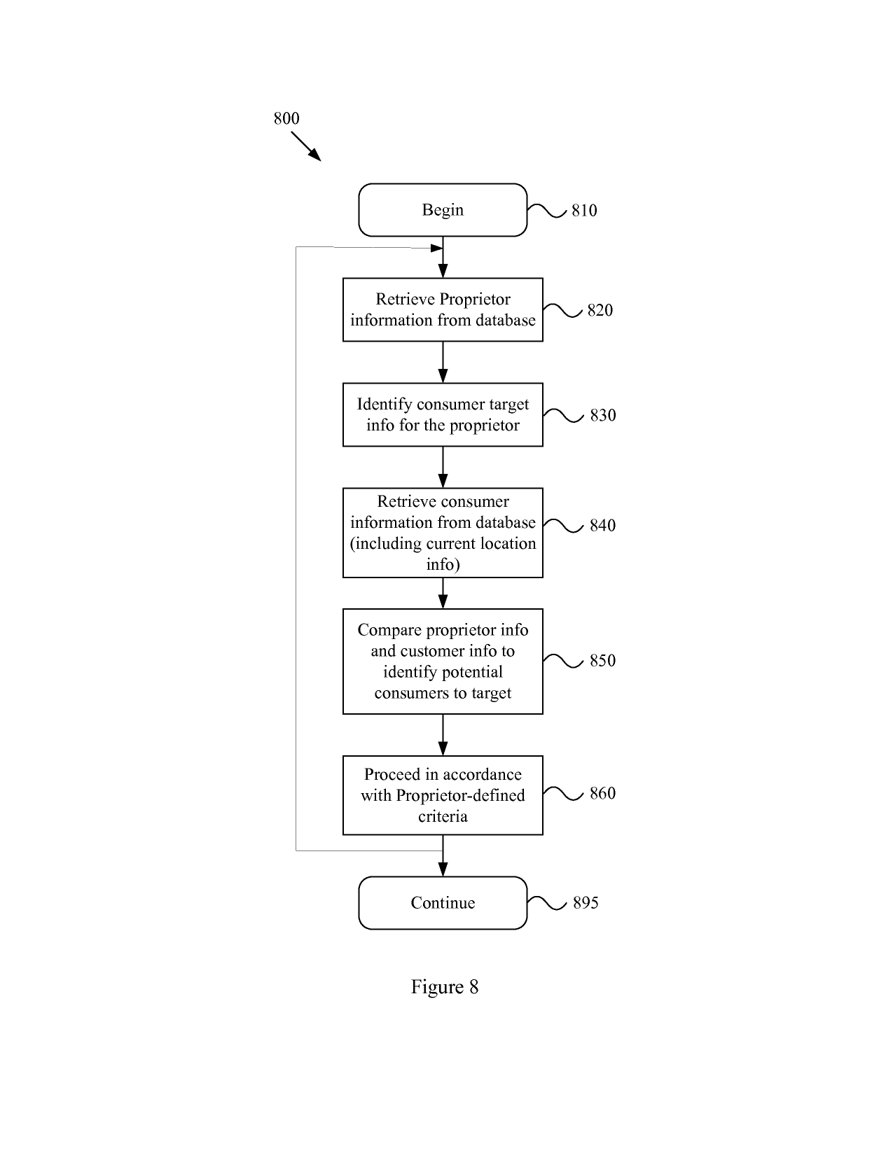

Turning to FIG. 8, such figure shows a non-limiting example flow diagram of a method 800 for communicating promotion content, in accordance with various aspects of the present invention. Such method 800 provides a non-limiting example of operation with relatively little, or no, proprietor interaction during the real-time promotion-providing process. The example method 800 may, for example, share any or all characteristics with the example methods 100-700 discussed previously and illustrated in FIGS. 1-7.

The method 800 begins executing at step 810. The method 800 may begin executing for any of a variety of reasons. For example and without limitation, the method 800 may operate in a continual loop, for example continually looping through steps 820-860, or any sequence of steps. Also for example, the method 800 may begin executing periodically, for example in response to a periodic timer. Additionally, for example, the method 800 may begin executing in response to a predefined time schedule (e.g., a schedule set up by each proprietor in accordance with the proprietor's desires). Additionally, for example, the method 800 may begin executing in response to a triggering condition, for example related to detection of one or more customers within a geographical vicinity of the proprietor. Further for example, the method 800 may begin executing in response to a real-time determination that the proprietor's level of business is below a desired threshold (e.g., based on a real-time receipt total, based on number of customers detected at the proprietorship, etc.). Also for example, the method 800 may begin executing in response to a consumer inquiry into whether a particular proprietor (or set of proprietors, or all proprietors) is presently offering promotions. In general, the method 800 may begin executing for any of a variety of causes or conditions. Accordingly, the scope of various aspects of the present invention should not be limited by characteristics of any particular initiating cause or condition unless explicitly claimed.

The method 800 may, at step 820, comprise retrieving proprietor information from a database. Many characteristics of such information and/or database were discussed previously. Step 820 may, for example, comprise retrieving information regarding proprietor identity, proprietor location, manner in which a proprietor desires to communicate promotions to consumers, characteristics of promotions, information regarding the consumers and/or types of consumers targeted by the proprietor, information regarding the criteria that needs to be met before a particular promotional offer is to be extended to a consumer or group thereof, etc.

The method 800, at step 830, may comprise identifying consumer target information for the proprietor. As explained previously, a proprietor may specify characteristics of consumers to whom promotional offers should be extended. Many examples of such characteristics were provided above, for example consumer location, consumer identity, present consumer activity, size of a consumer group, consumer VIP status, new consumer status, etc. For example, step 830 may generally comprise retrieving information from a database that can be used by the method 800 to determine whether to communicate a promotional offer to a particular consumer or a particular set of consumers, the characteristics of such an offer, etc.

The method 800 may, at step 840, comprise retrieving consumer information from a database. Many examples of such consumer information and database were provided previously. For example and without limitation, such information may comprise consumer location information, types of promotions in which a consumer is interested, conditions under which a consumer desires to receive promotional information, manner in which a consumer desires to receive promotional information, group definitions, etc. For example, step 840 may generally comprise retrieving information from a database that can be used by the method 800 to determine whether to communicate a promotional offer to a particular consumer or a particular set of consumers, the characteristics of such offer, etc.

The method 800 may, at step 850, comprise processing (e.g., comparing) the retrieved consumer and proprietor information to identify one or more consumers to target with promotional information. Many examples of such processing were presented previously, for example, comprising identifying one or more consumers at which to direct promotional information based, at least in part, on the geographical location of such consumer(s). For example and without limitation, step 850 may comprise determining whether the consumer and/or proprietor are located within each other's expressed range of interest. Also for example, step 850 may comprise identifying the consumers that have expressed an interest in the Proprietor and/or the Proprietor's goods/services and that are also within a particular distance of the Proprietor's location. Additionally for example, step 850 may comprise determining whether a proprietor rating meets or exceeds a minimum rating specified by a consumer. Many non-limiting examples of various considerations have been provided herein. In general, step 850 may comprise processing consumer and proprietor information, for example location information, to identify one or more consumers to target with promotional information. Accordingly, the scope of various aspects of the present invention should not be limited by characteristics of any particular manner of performing such identifying unless explicitly claimed.

The method 800 may, at step 860, comprise proceeding (e.g., communicating with consumers regarding promotional content) in accordance with proprietor-defined criteria. Step 860 may, for example, comprise proceeding automatically without present proprietor input. Many example aspects of communicating promotional information with consumers were presented previously.

For example and without limitation, step 860 may comprise communicating a proprietor-specified promotional offer to one or more consumers, performing offer acceptance tasks, performing billing tasks, performing coupon redemption tasks, performing counter-offer tasks, navigational tasks, etc.

Execution of the method 800 may, for example after executing step 860, flow back up to step 820. For example, such looped operation may be performed continuously, in a periodic timed manner, etc. Also for example, execution of the method 800 may flow to continued operation at step 895, at which any of a variety of operation may be performed, many examples of which are provided here. For example and without limitation, step 895 may comprise performing consumer and/or proprietor interaction (e.g., in accordance with any one or more of the steps discussed previously with regard to FIGS. 1-7).

The previous discussion of the method 800 illustrated in FIG. 8 generally concerned a non-limiting example of automatic system operation, for example operation that did not involve real-time involvement of a proprietor. The discussion will now turn to discussion of a non-limiting example of a method for communicating promotion content that may involve at least some real-time interaction with a proprietor.

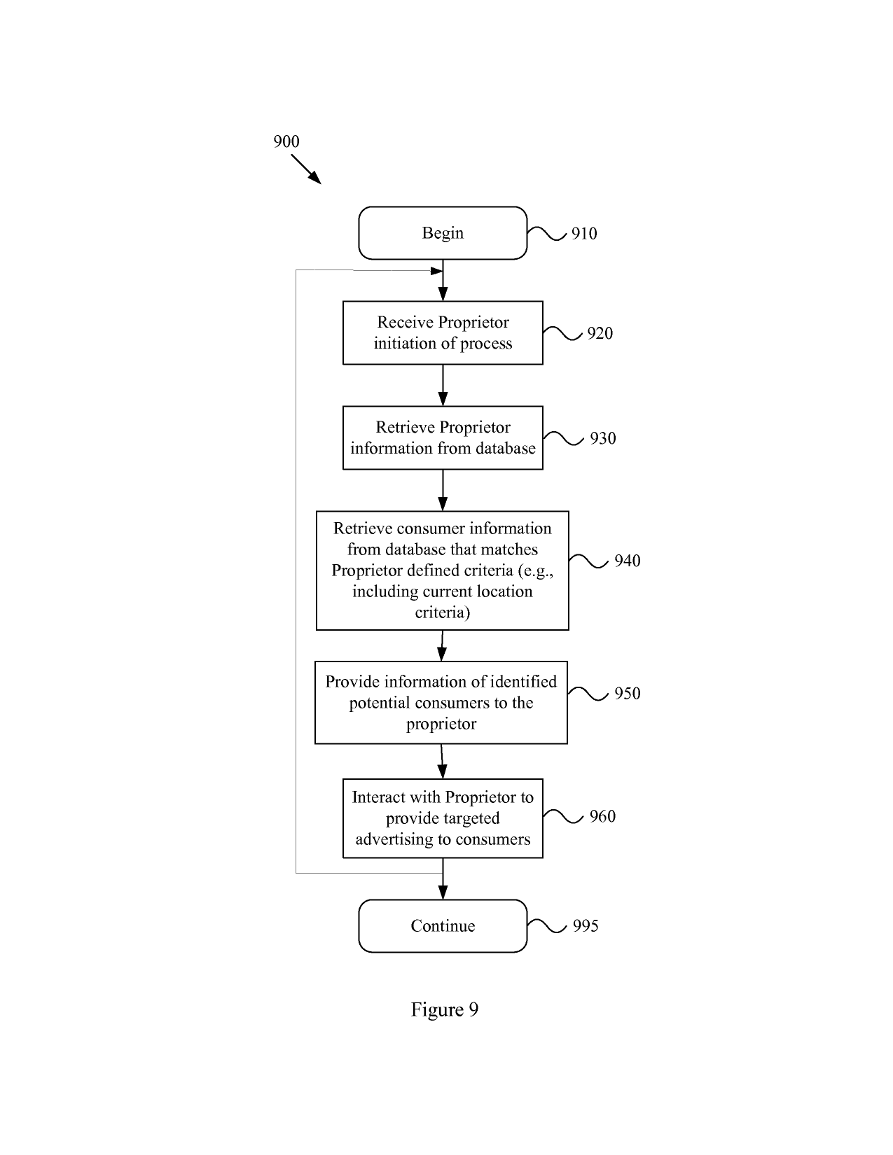

Turning next to FIG. 9, such figure shows a non-limiting example flow diagram of a method 900 for communicating promotion content, in accordance with various aspects of the present invention. The example method 900 may, for example, share any or all characteristics with the example methods 100-800 discussed previously and illustrated in FIGS. 1-8.

The example method 900 may begin execution at step 910. Step 910 may, for example, share any or all characteristics with step 810 of the method 800 illustrated in FIG. 8 and discussed previously. For example, step 910 may execute upon boot-up of a computing device, upon execution of a software application by a proprietor, upon expiration of a timer, upon detection of particular business conditions, upon detection of a consumer-location related promotional opportunity (e.g., detection of the geographical nearness of a consumer, a consumer gathering at a particular location, etc.), etc.

The example method 900 may, for example at step 920, comprise receiving or detecting proprietor initiation of the method 900. As mentioned previously, such initiation may comprise a proprietor execution an application implementing at least a portion of the method 900, pushing a start button on a user interface, logging into an executing software application with a correct password, etc.

The example method 900 may, for example at step 930, comprise retrieving proprietor information from a database. Many examples of such information and database(s) were discussed previously. Step 930 may, for example, share any or all characteristics with step 830 of the method 800 illustrated in FIG. 8 and discussed previously. Step 930 may, for example, comprise retrieving information regarding proprietor identity, proprietor location, manner in which a proprietor desires to communicate promotions to consumers, characteristics of promotions, information regarding the consumers and/or types of consumers targeted by the proprietor, information regarding the criteria that needs to be met before a particular promotional offer is to be extended to a consumer or group thereof, information of predefined promotional offers, information of predefined targeted consumer and/or consumer groups, etc.

The method 900, for example at step 940, may comprise retrieving consumer information from a consumer database that matches proprietor-defined criteria (e.g., at least proprietor-defined consumer location criteria). For example, step 940 may, for example, share any or all characteristics with steps 840 and/or 850 of the example method 800 illustrated in FIG. 8 and discussed previously. For example, step 940 may comprise searching a consumer database for consumers located within a particular distance of the proprietor's location, at a particular defined venue, etc. Step 940 may further for example comprise searching the consumer database for consumers that have expressed in an interest (e.g., a general interest or an immediate interest) in the goods/services provided by the proprietor, that have a history or no history of doing business with the proprietor, that have formed a group of consumers of a particular size, etc. Many non-limiting aspects of proprietor and/or consumer-defined criteria have been provided herein.

The method 900, for example after having identified one or more consumers at step 940, may comprise at step 950 providing information of identified consumers to the proprietor. For example, step 950 may comprise presenting a textual list of potentially-interested consumers located within a particular distance of the proprietor, presenting a graphical map showing respective locations of consumers and/or groups thereof, showing graphical and/or textual indications of consumer history with the proprietor, etc. Also for example, step 950 may comprise providing any or all of the different types of consumer-related information discussed herein to the proprietor. The proprietor may thus consider such information in identifying one or more consumers to target with a directed promotional offer. In general, step 950 may comprise providing information of identified consumers to the proprietor. Accordingly, the scope of various aspects of the present invention should not be limited by characteristics of any particular manner of providing such information, nor of particular types of information, unless explicitly claimed.

The method 900 may, for example at step 960, comprise interacting with a proprietor to provide targeted (or directed) advertising to one or more consumers. As discussed above with regard to step 950, the method 900 may present any of a variety of different types of consumer-related information to a proprietor (e.g., consumer location information, etc.). Step 960 may, for example, comprise providing a user interface to a proprietor by which the proprietor may specify that a promotional offer (e.g., having any of the promotional offer characteristics discussed herein) be extended to a particular consumer, particular set of consumers, particular number of consumers, etc. For example, step 960 may comprise receiving a graphical input (or other) from a proprietor selecting a set of consumers to which a promotional offer is to be extended. Also for example, step 960 may comprise receiving an indication from the proprietor that all consumers identified at step 950 are to be extended a particular promotional offer (e.g., until a particular number of such offers are accepted, until a particular time duration expires, unconditionally, etc.). Additionally for example, step 960 may comprise interacting with the proprietor to identify a sequence of promotional offers that are to be extended to a group or series of consumers.

Further, as mentioned above, interacting with a proprietor may comprise communicating with the proprietor regarding counter-offers received from consumers. In such a scenario, step 960 may comprise performing such interaction, for example acting as an intermediary between the proprietor and the consumer(s).

In general, step 960 may comprise interacting with a proprietor to provide targeted (or directed) advertising to consumers (e.g., based at least in part on consumer location). Accordingly, the scope of various aspects of the present invention should not be limited by characteristics of any particular type of such interacting unless explicitly claimed.

Execution of the method 900 may, for example after executing step 960, flow back up to step 920. For example, such looped operation may be performed continuously, in a periodic timed manner, so long as proprietor interaction continues, etc. Also for example, execution of the method 900 may flow to continued operation at step 995, at which any of a variety of continued operations may be performed, many examples of which have been provided herein. For example and without limitation, step 995 may comprise performing consumer and/or proprietor interaction (e.g., in accordance with any one or more of the steps discussed previously with regard to FIGS. 1-8).

The previous discussion of the method 100-900 illustrated in FIGS. 1-9 generally concerned non-limiting examples of methods or steps thereof for interacting with consumers, interacting with proprietors, and providing promotional content to consumers (e.g., based at least in part on consumer location). Such methods may be performed by one or more systems in any of a variety of system configurations. For example, such systems may be architected centrally, in a distributed manner, etc. The following discussion will provide insight into one or more example systems that may perform any or all of the method aspects discussed previously.

Any or all functional aspects discuss herein, for example with regard to FIGS. 1-9, may be implemented utilizing hardware, software and/or a combination of hardware and software. Generically, such implementations will be discussed herein as “modules”. Though the modules discussed below are shown on the same page, for example, for illustrative clarity, such modules (or portions thereof) may be located at geographically distinct locations.

Also for example, a particular module may often have a counterpart module in another electronic device or system component. As a non-limiting example, a first consumer interface module may be located at a central location that manages operation of the overall system, and a second consumer interface module may be located at a consumer's personal electronic device. As another non-limiting example, a first proprietor interface module may be located at a central location, and a second proprietor interface module may be located at a proprietor's electronic device. As another example, consumer tracking modules at the system level may communicate with corresponding consumer tracking modules at the user device level. Note however, that such implementation is not necessary. For example, a module at the system level may communicate with individual users (e.g., a proprietor and/or potential customer) utilizing a generic web interface (e.g., a web browser application) at the end user level.

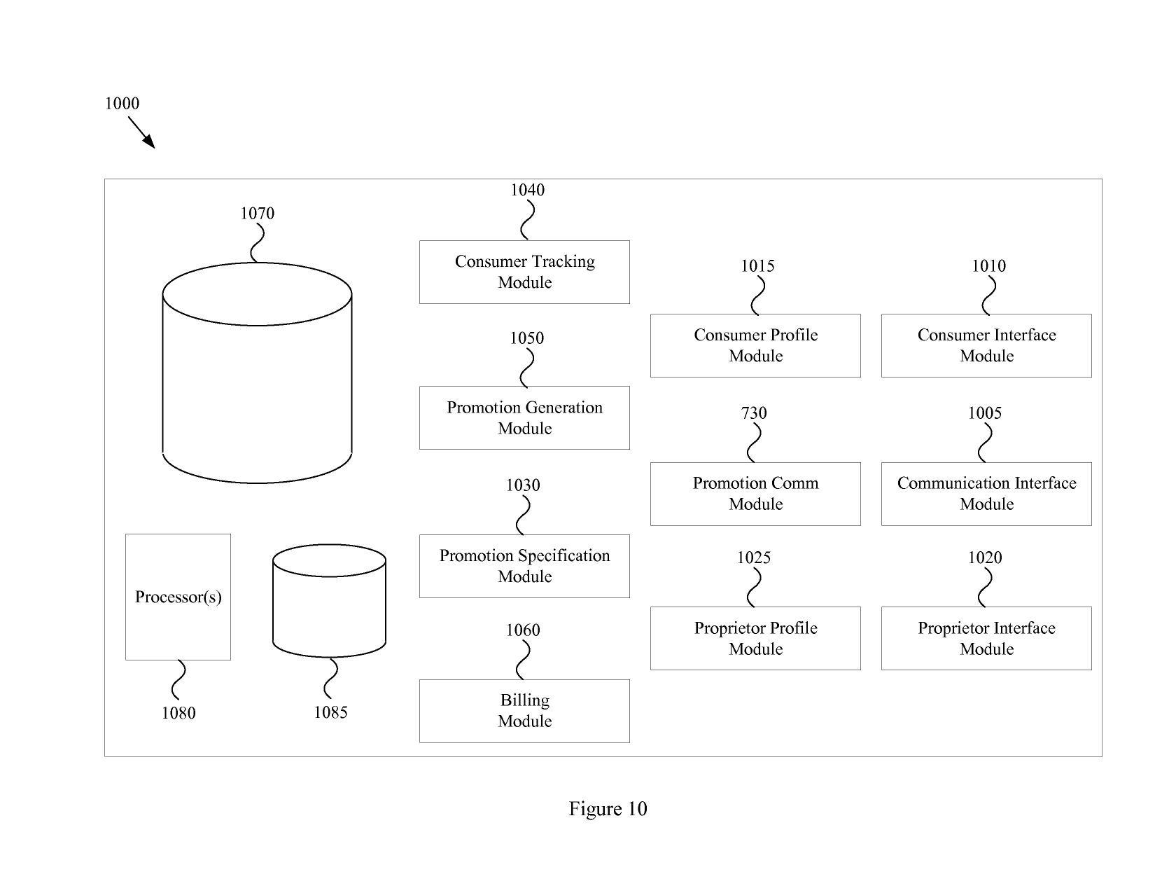

Further, the boundaries between various modules (for example in FIG. 10) were selected for illustrative clarity, and not necessarily to show complete distinction between such modules. For example, various modules may share various hardware and/or software components.

In light of the previous comments, unless such modules are explicitly stated to reside in a particular device or at a particular location, or unless such modules are explicitly stated to be independent of one another, the scope of various aspects of the present invention should not be limited by the illustrative distinctions shown in the figures.

Turning now to FIG. 10, such figure shows a diagram of a system 1000 in accordance with various aspects of the present invention. As mentioned above, such a system 1000 may, for example, be geographically distributed and/or collocated (e.g., located at a common premise or within a single housing). For example, such a system 1000 may be a central system controller that manages operation of the promotion delivery system. Also for example, any or all components of the illustrated system 1000 may be located in a proprietor's device. Additionally for example, any or all components of the illustrated system 1000 may be located in a consumer's device.

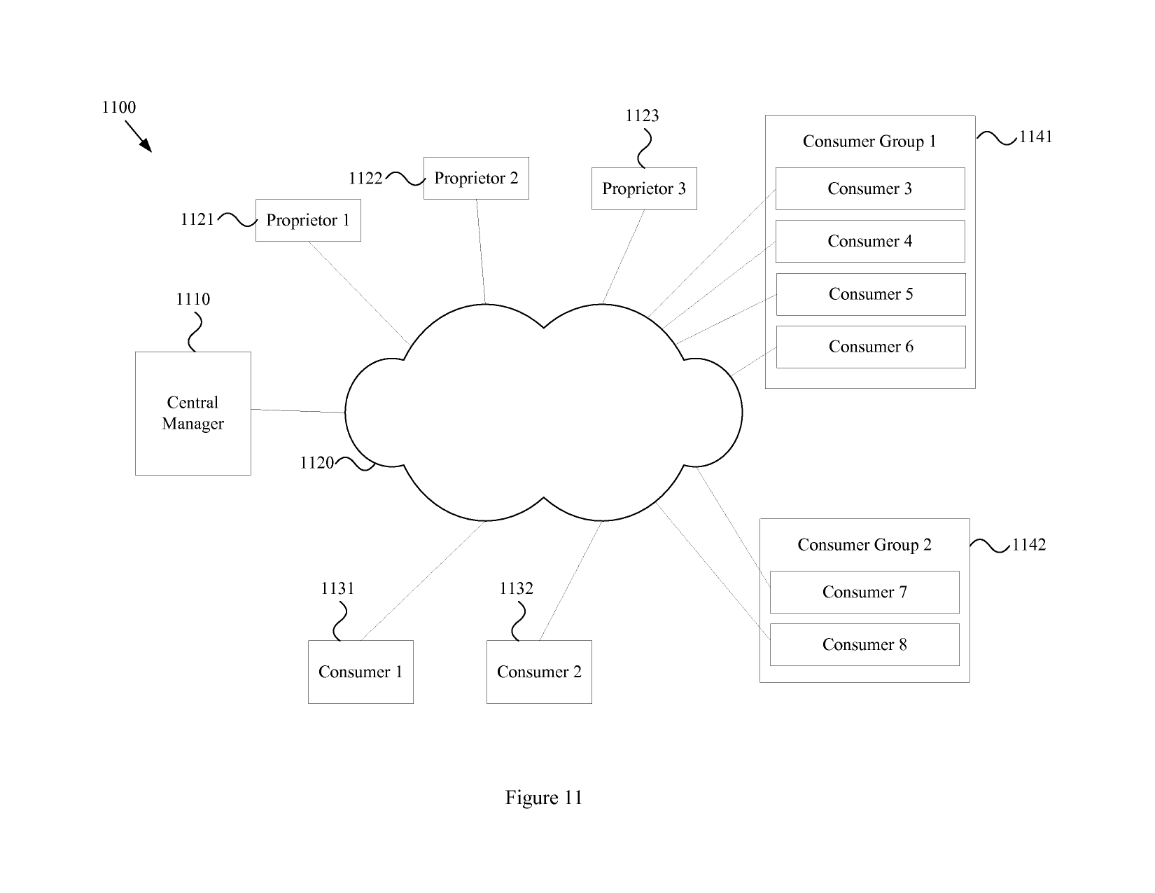

Turning briefly to FIG. 11, such figure shows a diagram of a distributed system 1100 in accordance with various aspects of the present invention. Such a distributed system 1100 may, for example, comprise a central manager 1110 for the promotion delivery system 1100. Such a system 1100 may also, for example, comprise a plurality of individual consumers 1131, 1132 and/or groups of consumers 1141, 1142. Such a system 1100 may additionally, for example, comprise a plurality of proprietors 1121, 1122, 1123. The various entities may, for example, be communicatively coupled via one or more communication networks 1120 (e.g., one or more of the Internet, a telecommunication network, a television network, a satellite network, etc.). Such entities may, for example, be communicatively coupled via any one or more of a plurality of communication media (e.g., wireless communication, wireless LAN, wireless WAN, wired network, optical network, satellite RF network, etc.).

Turning back to FIG. 10 and the system 1000 presented therein, many example aspects of the present invention concerning interacting with one or more consumers of a customer base were presented previously. For example and without limitation, refer to the flow diagrams illustrated in FIGS. 2, 3, and 4, and related discussions. The system 1000 may, for example, comprise one or more hardware and/or software module(s) (e.g., a Customer Profile Module 1015) that operate to perform interaction with consumers to specify the manner in which the system 1000 is to interact with the consumers. Such a Customer Profile Module 1015 may, for example, utilize the Consumer Interface Module 1010 to provide a user interface with a consumer.

The system 1000 may also, for example, comprise one or more hardware and/or software module(s) (e.g., a Promotion Communication Module 1017) that operate to communicate promotion content to and/or from a consumer and/or set of consumers, for example based at least in part on the detected location of such consumers(s). The Promotion Communication Module 1017 may, for example, utilize a Communication Interface Module 1005 to provide and/or maintain a promotional communication link with a consumer.

Many non-limiting examples of interacting with proprietors (e.g., people generally associated with ownership and/or management of a commercial enterprise providing goods and/or services) were presented above. For example and without limitation, refer to the flow diagrams illustrated in FIGS. 2, 5, and 6, and related discussions. The system 1000 may, for example, comprise one or more hardware and/or software module(s) (e.g., a Proprietor Profile Module 1025) that operate to perform interaction with proprietors to specify the manner in which the system 1000 is to interact with the proprietors. Such a Proprietor Profile Module 1025 may, for example, utilize the Proprietor Interface Module 1020 to provide a user interface with a proprietor.

Many non-limiting examples of promotion characteristics were presented above. The system 1000 may, for example, comprise one or more hardware and/or software module(s) (e.g., a Promotion Specification Module 1030) that operate to interact with proprietors to define characteristics of promotion information to be communicated with consumers. The Promotion Specification Module 1030 may, for example utilize the Proprietor Interface Module 1020 to interface with proprietors about promotional characteristics and/or the Consumer Interface Module 1010 to interface with consumers about promotional characteristics.

Non-limiting examples of such promotion information may include price information and/or timing information (e.g., offer expiration time/date) regarding a proprietor's offer. For example, the time duration associated with an offer can be less than a day, less than 6 hours, less than 3 hours, less than 2 hours, less than an hour, etc. The promotion information may also, for example, specify any of a variety of terms or conditions associated with the promotion.

Also for example, the promotion information may comprise counter-offer information (e.g., as received from a consumer via the Consumer Interface Module 1010). In such a scenario, the system 1000 (e.g., the Consumer Interface Module 1010) may provide a user interface for such counter-offers and/or negotiations. For example, a targeted group or consumer may be provided with a user interface by which a targeted consumer and/or group may present a counter-offer to a received offer (e.g., stating that they desire $30 off instead of $20 off, 2.5-for-1 instead of 2-for-1, etc.).

As discussed above, any of a variety of types of promotion information may be delivered to a targeted customer. The manner in which such information is to be provided to a customer may also be specified (e.g., determining the medium via which a particular customer is to be contacted). For example, the same general promotion content may be delivered to a plurality of customers, each with a respective preferred or enabled manner of contacting. For example, as discussed above, a customer may specify the manners of contact that are enabled and/or allowed (e.g., text message, MMS, email contact, voice message, social networking message, etc.). Also for example, a proprietor may specify a preferred (or default) manner of communication, which may also be considered by the system when determining how to provide promotion content to a particular customer. Further for example, a proprietor may specify a duration for which a promotional offer is valid.

As discussed previously, various aspects of the present invention concern determining the location of one or more consumers. Many non-limiting example of such location determining were presented previously. As a non-limiting example, consider the method 100 illustrated in FIG. 7 and the discussion thereof. The system 1000 may, for example, comprise one or more hardware and/or software module(s) (e.g., a Customer Tracking Module 1040) that operate to determine respective locations for consumers.

Such a Customer Tracking Module 1040 may, for example, operate to receive location information from user devices associated with consumers. For example, a local application executing on a customer device (e.g., a personal communication device, smart phone, etc.) may interface with a local location-determining module of the user device to obtain the location information for the customer. Such local application may then communicate such location information to a central system location (e.g., to the Customer Tracking Module 1040) for processing. In another example, a local application executing on a consumer's device may interface with communication infrastructure apparatus (e.g., portions of a cellular network, local area network, etc.) to ascertain the location of the consumer device. Such local application may then communicate such location information to a central system location (e.g., to the Customer Tracking Module 1040) for processing. In such example scenarios, the timing regarding the communication of consumer location information to the system 1000 may vary. Such communication may occur periodically, upon a detected change in location, upon customer command, upon system command (e.g., requesting location information from a customer device), etc.

In another example, the system 1000 may (e.g., periodically or in response to any triggering event) contact communication services providers for information of the location of consumer devices associated with a customer that has registered for a promotion delivery service. In yet another example, the system 1000 (or the Consumer Tracking Module 1040) may solicit and/or receive location information from networks providing services (e.g., communication services) to customer devices. For example, as part of a customer registration process, the system 1000 (e.g., the Consumer Tracking Module 1040) may interact with the customer and/or a commercial enterprise providing services (e.g., communication services) to the customers to define the manner in which the system 1000 will obtain location information for the consumer.

In another example, the Consumer Tracking Module 1040 may receive location information directly from consumers, for example via the Consumer Interface Module 1010. For example, as mentioned previously, a customer may manually enter location information, for example utilizing the user interface capabilities of the consumer's personal electronic device. Such information may, for example, comprise address information, geographical coordinates, intersection information, neighborhood information, business name, landmark name, venue name, etc. Such information may then be communicated to the system 1000 (e.g., a central location thereof).

The system 1000 may operate to process consumer profiles, proprietor profiles, and location information (e.g., location of the customers and/or proprietors) to determine whether and/or how to generate/communicate promotion information. Many non-limiting examples of the system determining when and/or how to deliver promotional content to potential customers (e.g., based at least in part on customer location information) were presented above (e.g., in the discussions of FIGS. 1-9). The system 1000 may, for example, comprise one or more hardware and/or software module(s) (e.g., a Promotion Generation Module 1050) that operate to determining whether to communicate promotional offers, determine characteristics of promotional offers, and communicate promotional offers with consumers (e.g., utilizing the Promotion Communication Module 1017).

As discussed above, such processing may comprise considering many types of information (e.g., consumer location information, consumer profile information, consumer movement information, proprietor location information, proprietor profile information, number of potential consumer, any of a large variety of promotion generation triggers, real-time interaction with proprietors, real-time interaction with potential consumer, any real-time condition related to commerce, etc.) when determining whether and/or how to generate/communicate real-time promotion information to one or more consumer. Note that the Promotion Generation Module 1050 may work in conjunction with any other modules discussed herein (e.g., The Consumer Tracking Module 1040, Consumer and/or Proprietor Interface modules 1010, 1020, Communication Interface Module 1005, database management modules, etc.).

As discussed previously, for example with regard to the method 800 of FIG. 8, the system may automatically deliver promotion contact to selected customers. Any or all of such functionality may, for example, be performed by the Promotion Generation Module 1050. Similarly, as discussed previously, for example with regard to the method 900 of FIG. 9, the system may interact with a proprietor in real-time (e.g., utilizing the Proprietor Interface Module 1020) to guide promotion-delivery activity. Any of all of such functionality may, for example, be performed by the Promotion Generation Module 1050.

Additionally, as discussed previously, various aspects of the present invention may provide navigational information to a consumer, for example guiding a consumer to the proprietor's establishment. Such functionality may, for example, be performed by a hardware and/or software module of the system 1000. For example, consumer location information may be communicated vie the communication interface module 1005 and/or consumer interface module 1010.

Further, as discussed previously, various aspects of the present invention may be related to performing billing (e.g., of the consumer and/or proprietor). The system 1000 may also, for example, comprise one or more hardware and/or software module(s) (e.g., a Billing Module 1060) that operate to perform such billing functionality. The Billing Module 1060 may, for example, utilize the Consumer Interface Module 1010 to communicate billing information with a consumer, utilize the Proprietor Interface Module 1020 to communicate billing information with a proprietor, and/or utilize the Communication Interface Module 1005 communicate billing information with a financial institution.

Portions of the previous discussions concerned storing particular information in one or more databases. The example system 1000 is illustrated with two storage devices 1070 and 1085. For example, one of such storage devices may be utilized for the storage of consumer and/or proprietor profile information, and a second of such storage devices may be utilized to store computer source code for general operation of the system 1000. Note that such storage devices do not have to be co-located. For example, in an example system configuration, a storage device that stores customer and/or proprietor information may be located at a location different from the majority of the system 1000.

The system 1000 further includes one or more processors 1080. Such processor(s) 1080 may, for example, operate in accordance with software instructions to implement any of the previously discussed modules or portions thereof.

In summary, various aspects of the present invention provide system and method for providing location-based promotions. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for providing location-based promotions, the method comprising:
determining a current location of a mobile potential customer;
providing the current location of the mobile potential customer to a proprietor;
determining, based at least in part on information received from the proprietor, whether to communicate a promotional offer to the mobile potential customer; and
if it is determined to communicate a promotional offer to the customer, then communicating the promotional offer to the mobile potential customer.

2. The method of claim 1, wherein said determining a current location comprises obtaining the current location from a personal electronic device.

3. The method of claim 1, wherein said determining a current location comprises obtaining the current location from a system that provides mobile communication services.

4. The method of claim 1, comprising interacting with the mobile potential customer to determine types of promotional information in which the mobile potential customer has a present interest.

5. The method of claim 1, comprising interacting with the mobile potential customer to determine a distance within which the mobile potential customer is interested in receiving promotional information from a proprietor.

6. The method of claim 1, comprising interacting with the proprietor to determine a distance within which the proprietor is interested in providing promotional information to a consumer.

7. The method of claim 1, comprising providing real-time consumer location information to the proprietor.

8. The method of claim 1, comprising receiving from the proprietor a selection of one or more particular potential customers to which the proprietor wishes to immediately extend a promotional offer.

9. A method for providing location-based promotions, the method comprising:
determining a current location of a mobile potential customer;
determining based, at least in part on the determined current location of the mobile potential customer, to contact a proprietor;
interacting with the proprietor to determine whether to communicate a promotional offer to the mobile potential customer; and
if it is determined to communicate a promotional offer to the customer, then communicating the promotional offer to the customer.

10. The method of claim 9, wherein said determining a current location comprises obtaining the current location from a personal electronic device.

11. The method of claim 9, wherein said determining a current location comprises obtaining the current location from a system that provides mobile communication services.

12. The method of claim 9, comprising interacting with the mobile potential customer to determine types of promotional information in which the mobile potential customer has a present interest.

13. The method of claim 9, comprising interacting with the mobile potential customer to determine a distance within which the mobile potential customer is interested in receiving promotional information from a proprietor.

14. The method of claim 9, comprising interacting with the proprietor to determine a distance within which the proprietor is interested in providing promotional information to a consumer.

15. The method of claim 9, comprising providing real-time consumer location information to the proprietor.

16. The method of claim 9, comprising receiving from the proprietor a selection of one or more particular potential customers to which the proprietor wishes to immediately extend a promotional offer.

17. A method for providing location-based promotions, the method comprising:
obtaining real-time consumer location information;
presenting the obtained real-time consumer location information to a proprietor;
interacting with the proprietor to determine whether to communicate a promotional offer to one or more potential customers; and
if it is determined to communicate a promotional offer to one or more potential customers, then communicating the promotional offer to the one or more potential customers.

18. The method of claim 17, wherein said obtaining real-time consumer location information comprises obtaining the real-time consumer location information from a personal electronic device.

19. The method of claim 17, wherein said obtaining real-time consumer location information comprises obtaining the real-time consumer location information from a system that provides mobile communication services.

20. The method of claim 17, comprising interacting with a mobile potential customer to determine types of promotional information in which the mobile potential customer has a present interest.

21. The method of claim 17, comprising interacting with a mobile potential customer to determine a distance within which the mobile potential customer is interested in receiving promotional information from a proprietor.

22. The method of claim 17, comprising interacting with the proprietor to determine a distance within which the proprietor is interested in providing promotional information to a consumer.

23. The method of claim 17, comprising providing real-time consumer location information to the proprietor.

24. The method of claim 17, comprising receiving from the proprietor a selection of one or more particular potential customers to which the proprietor wishes to immediately extend a promotional offer.

25. A method for providing location-based promotions, the method comprising:
receiving information from a consumer regarding receiving promotional information;
receiving information from a proprietor regarding providing promotional information;
determining a location of a consumer;
determining, based at least in part on the determined location, the information received from the consumer, and the information received from the proprietor, whether to communicate information of a promotion to the consumer; and
if it is determined to communicate a promotional offer to the customer, then communicating the promotional offer to the customer.

26. The method of claim 25, wherein said determining a location of a customer comprises obtaining the current location of the customer from a personal electronic device.

27. The method of claim 25, wherein said determining a current location of a customer comprises obtaining the current location of the customer from a system that provides mobile communication services.

28. The method of claim 25, comprising interacting with the customer to determine types of promotional information in which the customer has a present interest.

29. The method of claim 25, comprising interacting with the customer to determine a distance within which the customer is interested in receiving promotional information from a proprietor.

30. The method of claim 25, comprising interacting with the proprietor to determine a distance within which the proprietor is interested in providing promotional information to a consumer.

31. The method of claim 25, comprising providing real-time consumer location information to the proprietor.

32. The method of claim 25, comprising receiving from the proprietor a selection of one or more particular potential customers to which the proprietor wishes to immediately extend a promotional offer.
